(19) United States
(12) Patent Application Publication
(10) Pub. No.: US 2008/0246912 A1
(43) Pub. Date: Oct. 9, 2008

(54) Liquid crystal display

(75) Inventors: Daisuke Inoue, Kanagawa (JP); Mitsuhiro Sugimoto, Kanagawa (JP); Toshihiko Motomatsu, Kanagawa (JP); Hisashi Kuwata, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD TECHNOLOGIES, LTD., Kawasaki (JP)

(21) Appl. No.: 12/076,660

(22) Filed: Mar. 20, 2008

(30) Foreign Application Priority Data
Mar. 23, 2007 (JP) 2007-076696

(51) Int. Cl. C09K 19/04

(52) U.S. Cl. 349/182

(57) ABSTRACT

The present invention provides a liquid crystal display (LCD) which is an active-matrix addressing LCD prepared by a drop filling and substrate assembling method, prevents an occurrence of a drop mark, and has superior residual image characteristics. The residual image characteristics are improved by adding an acidic compound (for instance, phenol derivative 412) into a liquid crystal composition to adjust a dielectric constant. The occurrence of the drop mark is prevented by adding a compound (for instance, alkoxy compound 413) which can form a hydrogen bond with the acidic compound into the liquid crystal composition so as to prevent the acidic compound from forming the hydrogen bond with water 409 when the LC composition has been dropped on a substrate. In a progressive mode, the content of the phenol compound is 0.00010 N or more, and the content of the alkoxy compound is 0.265 mol/L or less and is 10 equivalents or more with respect to the phenol compound. In an interlace mode, the content of the phenol compound is 0.00100 N or more, and the content of the alkoxy compound is 1.324 mol/L or less and is 150 equivalents or more with respect to the phenol compound.

This application is based upon and claims the benefit of priority from Japanese patent application No. 2007-076696, filed on Mar. 23, 2007, the disclosure of which is incorporated herein in its entirety by reference.

### BACKGROUND OF THE INVENTION

1. Field of the Invention

The present invention relates to an active-matrix addressing liquid crystal display (LCD) using a lateral electric field drive system, which is manufactured by a liquid crystal (LC) dropping method of a drop filling and substrate assembling method of making an LC composition drop onto a substrate in a humid atmosphere such as in a clean room, has superior residual image characteristics and does not form a drop mark.

2. Related Art

Active-matrix addressing LCDs provided with such an active element as represented by a thin film transistor (hereinafter referred to as TFT) are widely used as display terminals, because they have a high image quality comparable to CRTs, and a slim, lightweight body. Active-matrix addressing LCDs have been used for smaller-sized display terminals such as portable devices, car navigation systems, and personal computers (PCs), but have recently found a wide application in TV sets, since production of larger mother glass plates has enabled larger-sized images to be displayed. LCDs are required to have such characteristics as high brightness, high contrast ratio, adequate gradation and high-chromaticity region, and in the TV use, are further required to have among others, such characteristics as high moving-image display performance and wide angular field of view.

The active-matrix addressing LCD includes a lateral electric field drive system, a VA (Vertical Alignment) system, and a TN (Twist Nematic) system. Among them, the lateral electric field drive system is advantageous for realizing the high moving-image display performance because the liquid crystals show a shorter response time in half tones, and has a smaller change of gradation-brightness characteristics in both front and diagonal visual fields, and also a higher contrast ratio in the diagonal visual field to provide a wider angular field of view; and thus it is suitable for the TV use. Both VA and TN systems of active-matrix addressing LCD form an electrode for driving liquid crystals on surfaces of two substrates and operates the liquid crystal by applying an electric field perpendicular to the substrates by using the electrode which is arranged so as to oppose the substrates. On the other hand, the lateral electric field drive system operates the liquid crystal by applying voltage to a pair of comb-like electrodes provided on one substrate, and generating an electric field in a parallel direction to the substrate.

The active-matrix addressing LCD using a lateral electric field drive system accommodates a small capacitance of the liquid crystal because of having a different electrode structure from that of VA and TN systems, and consequently is easily affected by an electric field. For this reason, the lateral electric field drive system occasionally causes an orientation disorder due to an abnormal electric field, and particularly when an electrostatic charge is accumulated in the vicinity of a liquid crystal layer of the LCD by some reason, the orientation disorder which has been generated by an electric field originating in the electrostatic charge tends to cause a problem as an residual image in the display.

As a method for preventing the orientation disorder, Japanese Patent Laid-Open No. 7-306417 (D1) discloses a technique of using a liquid crystal with low specific resistance. The D1 describes that it is an effective countermeasure to decrease the resistance of the liquid crystal, because a method of expanding the gap between electrodes in order to increase an aperture ratio in the lateral electric field drive system further reduces the capacitance of the liquid crystal and tends to disorder the orientation by static electricity. In addition, Japanese Patent Laid-Open No. 11-302652 (D2) discloses a technique of adding 10 ppm to 10 wt % of an acidic mesogenic compound such as a phenol derivative, as a means of adjusting the specific resistance of the liquid crystal to a specified value beforehand. The D2 describes that a method of adding the disclosed acidic mesogenic compound such as the phenol derivative to a liquid crystal composition lowers the specific resistance of the liquid crystal composition, hinders electrostatic charge from accumulating in the vicinity of the liquid crystal layer of the LCD, and thereby inhibits a residual image originating in a high specific resistance of the liquid crystal composition. The D2 discloses that a representative acidic mesogenic compound such as the phenol derivative is 2-cyano-3-fluoro-5-(4-n-propyl-trans-cyclohexyl)phenol, and that the specific resistance comparatively mildly changes in the above described range of the adding amount. Accordingly, it is considered that the acidic mesogenic compound is suitable as a material for lowering the resistance of the liquid crystal, which is necessary for the lateral electric field drive system.

A drop and laminate method described in “Related Art” of Japanese Patent Laid-Open No. 2006-133251 (D3) is widely used as a method of filling liquid crystals in between two substrates in a process of manufacturing an LCD.

The drop and laminate method includes applying a sealing material to and dropping the liquid crystal on one substrate in the clean room atmosphere, laminating the substrate with the other substrate, forming a gap by pressurizing/flattening the sealing material by pressurizing a pair of the substrates or using the pressure difference between the inner side and the outer side of the pair of the substrates, and curing the sealing material. This method has characteristics of being capable of greatly shortening a process time because of directly dropping the liquid crystal onto the substrate and being capable of reducing a necessary amount of the expensive liquid crystal because of needing the minimum amount of the liquid crystal. The method also has an advantage of being capable of providing a structure which does not need to seal the inlet or has no inlet such as in a conventional injection method. The drop and laminate method will now be described with reference to FIG. 9.

At first, apply an polyimide solution onto the surface of both substrates of a substrate (TFT substrate) provided with a thin film transistor (TFT) and an opposing substrate provided with a color filter and a columnar spacer, by using a printer; temporarily burn the substrates; and fully burn the substrates to form an alignment layer with uniform thickness (step (A)).

Subsequently, subject the burnt substrates to a rubbing treatment of rubbing the surface of the alignment layer in a fixed direction, with a buffing cloth wound on a rotary metallic roller (step (B)). Then, clean and dry both of the substrates for the purpose of removing the residue on the substrate surface (step (C)).

Subsequently, apply Ag together with a sealing material made from a ultraviolet-curable resin or a thermosetting resin on one substrate (for instance, TFT substrate) of a pair of opposing substrates, with a screen printing technique or a dispenser drawing technique; spray a spacer like polymer beads or silica beads onto the other substrate (for instance, opposing substrate) with a wet spray technique or a dry spray technique; and fix the spacer (step (D) and (E)).

Next, drop an appropriate amount of the liquid crystal onto a display region surrounded by the sealing material on one substrate (here, TFT substrate) at normal pressure, by using a device for dropping the liquid crystal such as a dispenser for dropping the liquid crystal (step (F)). Then, align and laminate the substrate with the other substrate (here, opposing substrate) in a vacuum so that air bubbles cannot enter the space (step (G)). Subsequently, flatten the sealing material by pressing the pair of the substrates from both sides to form a desired gap, and temporarily cure the sealing material by irradiating the sealing material with ultra-violet rays from the rear face of a substrate (here, TFT substrate) (step (H)). Fully cure the sealing material by further heating the substrates at a predetermined temperature (step (I)); and cut the pair of the substrates at a predetermined part in the outside of the sealing material to form the LCD panel (step (J)).

The LCD manufactured by such a drop filling and substrate assembling method occasionally forms a drop mark (mark formed at position on substrate, at which liquid crystal has been dropped) which can cause display uneveness. For solving the problem, Japanese Patent Laid-Open No. 2003-156753 (D4) discloses a technique for eliminating the drop mark by installing a dehydrator between a container for storing the liquid crystal and a tool for dropping the liquid crystal and thereby removing water from the liquid crystal. In addition, Japanese Patent Laid-Open No. 2003-131244 (D5) discloses a technique for eliminating the drop mark by decreasing the velocity at which the liquid crystal is adsorbed to the alignment layer through dropping a previously cooled liquid crystal onto the substrate, and making the liquid crystal rapidly and uniformly spread in a spreading direction of the principal surface of the substrate before laminating the substrates.

The LCD needs to be driven by an alternating current (AC), because of easily causing a phenomenon such as a residual image (ghosting of image) when a direct current (DC) has been applied to the LCD. In the LCD unit, one sheet of screen (one frame) is usually displayed at a frequency of 60 Hz, and image signals for each of the screen (frame) are applied to the liquid crystal while the polarity of the image signals is reversed at a frequency of 30 Hz, which is called an inversion driving. There are three types of inversion driving methods. One is a flame inversion driving method of inputting signals having the same polarity into the whole screen and reversing the polarity every time after having driven a predetermined number of frames; another is a line inversion driving method of inputting signals having different polarities at every predetermined number of scanning lines and reversing the polarity every time after having driven a predetermined number of frames; and the other is a dot inversion driving method of inputting signals having different polarities at every predetermined number of dots and reversing the polarities every time after having driven a predetermined number of frames.

Image signals which have been inputted into a signal conversion circuit of an LCD from a signal source such as a personal computer generally draw all scanning lines in one time of scan, which is called as a progressive scanning method (progressive mode). On the other hand, image signals in current television broadcasting generally draw scanning lines with the use of an interlace scanning method (interlace mode) of an NTSC system. The interlace mode of the NTSC system is described in “Description of the Related Art” in Japanese Patent Laid-Open No. 9-236787 (D6). The interlace mode is a method of dividing image signals in one screen (one frame) into odd fields which collect only scanning lines of odd numbers and even fields which collect only scanning lines of even numbers, and alternately displaying the odd fields and the even fields; and is a technique which displays a smooth image on a display unit such as a CRT by reducing the amount of information to the half. In the NTSC system, one frame is formed of 525 scanning lines and interlace scans by a ratio of 2:1. In addition, one frame is drawn at a frequency of 30 Hz, and one field (odd field or even field) is drawn at a frequency of 60 Hz. However, among the 525 lines of the scanning lines, about 480 lines are actually displayed in a display region of the CRT.

When intending to display the image signals of the interlace mode on the LCD, it is necessary to convert the image signals to image signals of a not-interlaced mode (non-interlace mode or progressive mode). An operation of converting the image signals of the interlace mode to that of the progressive mode is referred to as interlace-to-progressive conversion (IP conversion), and the circuit therefor is referred to as an IP conversion circuit. When the image signals transmitted in the interlace scanning type of NTSC system is displayed on an LCD which has scanning lines with the number of about 480 lines and is operated by the inversion driving method at the frequency of 30 Hz at every frame, the image signals undergo IP conversion by a process described below. More specifically, the process specifically includes combining a frame of the odd number (or even number) of the LCD from image signals only of odd fields in the interlace mode among the image signals of odd fields and even fields in the interlace mode, and combining a frame of the even number (or odd number) of the LCD from image signals only of even fields in the interlace mode; for instance, in a display of each (2N−1)-th (where N is integer number of 1 or more) scanning line in odd fields of the interlace mode, displaying the (2N−1)-th scanning line and the 2N-th scanning line in an odd number flame in the LCD, and subsequently, in a display of each 2N-th scanning line in even fields of the interlace mode, displaying the (2N−1)-th scanning line and the 2N-th scanning line in an even number flame in the LCD.

When IP conversion of image signals in the interlace mode is made by the above described method to display a particular pattern such as a fixed pattern of a lateral stripe, a problem that DC voltage is applied to the liquid crystal occurs. FIGS. 10A to 10C illustrate views of voltages applied onto liquid crystals of arbitrary one pixel when the image signals of the interlace mode has been inputted into an LCD which is a normally black mode and reverses image signals to be inputted therein at every one frame. FIG. 10A illustrates a view of voltages applied to the liquid crystal when white is displayed. FIG. 10B illustrates a view of voltages applied to the liquid crystal when black is displayed. FIG. 10C illustrates a view of voltages applied to one pixel in a lateral stripe display in which white and black are alternately changed at every one scanning line in a horizontal direction. Suppose that the voltage applied to the liquid crystal for displaying white is E (V) and the voltage applied to the liquid crystal for displaying black is 0 (V). Then, when displaying white, the voltage of +E (V) (or −E (V)) is applied to the liquid crystal in odd fields and the voltage of −E (V) (or +E (V)) in even fields, as is shown in FIG. 10A, and when displaying black, 0 (V) is applied to in both odd fields and even fields, as is shown in FIG. 10B. In addition, in the lateral stripe display, the voltage of +E (V) (or −E (V)) is applied to the liquid crystal in odd fields and the voltage of 0 (V) is applied to the liquid crystal in even fields, or the voltage of 0 (V) in odd fields and the voltage of +E (V) (or −E (V)) in even fields, as is shown in FIG. 10C. In the above driving method for the LCD, DC voltage is not applied to the liquid crystal when white or black is displayed, but when the lateral stripe is displayed, only the voltage with positive polarity is applied, and E/2 (V) of DC voltage by average is applied to the liquid crystal, as is shown in FIG. 10C, which causes a problem of lowering a display quality such as a residual image. In the above, a fixed pattern of the lateral stripe was described as an example, but when black (or white) and white (or black) are displayed respectively on pixels adjacent on the (2N−1)-th and the 2N-th scanning lines, a similar problem occurs regardless of types (frame inversion, line inversion or dot inversion) of the inversion driving method.

As a method for solving the problem, D6 discloses the inversion driving method which reverses the polarity of the voltage applied to the liquid crystal every time after having displayed the predetermined number of frames, and further reverses the polarity at every predetermined number of the frames, in the “Mode for carrying out the invention”.

However, the above described related art has the problems described below.

The first problem is that a drop mark appears when inhibiting a residual image by decreasing the resistance of a liquid crystal composition. D2 discloses a technique of inhibiting the residual image by adding an acidic mesogenic compound such as a phenol derivative into the liquid crystal composition which is to be filled in an active-matrix addressing LCD using a lateral electric field drive system, but does not disclose a technique relating to a drop mark which occurs in an LCD manufactured by a drop filling and substrate assembling method.

On the other hand, as a method of solving the drop mark, D5 discloses a technique of eliminating the drop mark by decreasing the velocity at which the liquid crystal is adsorbed to the alignment layer through dropping a previously cooled liquid crystal onto the substrate, and making the liquid crystal rapidly and uniformly spread in a spreading direction of the principal surface of the substrate before laminating the substrates. As another method for solving the problem, D4 discloses a technique for eliminating the drop mark by installing a dehydrator between a container for storing the liquid crystal and a tool for dropping the liquid crystal, and thereby removing water from the liquid crystal. However, the two above-described known examples do not disclose either a technique for solving the residual image, or information about a liquid crystal composition, which closely relates to the residual image, and accordingly do not show the cause-effect relationship between the drop mark and a lowered resistance of the liquid crystal composition.

The second problem is that a residual image is hard to be inhibited in an LCD having image signals of an interlace mode inputted into a signal conversion circuit from a signal source. In contrast to the progressive mode, the residual image becomes a problem more often in the LCD in which the image signals of the interlace mode is inputted, because when a lateral stripe display is performed which alternately changes white and black at every one scanning line in a horizontal direction, the largest DC voltage is applied to the liquid crystal. An acidic mesogenic compound such as a phenol derivative disclosed in D2 is added to a liquid crystal composition so as to improve the residual image, but the publicly known example does not disclose a technique about a method for improving the residual image which appears when an excessive DC voltage is applied to the liquid crystal such as in the case when the image signals of the interlace mode is inputted, so that the problem of the residual image still remains when the interlace mode is employed.

The level of drop mark occurrence is considered to be closely related to the image signals inputted to the LCD and the conversion method thereof, however, D5 and D4 do not disclose any information on such relation thereof to the image signals and the conversion method thereof.

An IP conversion method for converting a driving signal disclosed in D6 as a countermeasure for the above described problem is effective in preventing the residual image from forming, but the above described IP conversion method has a problem that a driving circuit becomes expensive, because the signal processing procedure is complicated. In order to realize an inexpensive LCD for a television, a technique is desired which prevents the residual image without changing a conventional driving circuit, for instance, simply by changing component materials for a liquid crystal composition or manufacturing conditions to avoid an increase in the cost.

The third problem is that visible specks may occur. D2 discloses a technique of providing a liquid crystal composition having particular specific resistance by adding an acidic mesogenic compound such as a phenol derivative, but does not disclose the content and specific resistance of the acidic mesogenic compound such as the phenol derivative, which does not cause the visible specks.

In order to solve the above described problem, the present inventors have found that the visible specks constitute a phenomenon associated with the acidic mesogenic compound such as the phenol derivative, because an active-matrix addressing LCD using a lateral electric field system which is filled with the liquid crystal composition forms a drop mark when the composition contains the acidic mesogenic compound such as the phenol derivative disclosed in D2, and does not form any drop mark when the composition does not contain the acidic mesogenic compound. In other words, the liquid crystal composition disclosed in D2 cannot either eliminate drop marks, prevent visible specks or inhibit residual images. The above fact also means that the technique of solving the drop mark problem disclosed in D4 and D5 cannot prevent drop marks from occurring in the LCD which is filled with such a liquid crystal composition that inhibits residual images.

### SUMMARY OF THE INVENTION

An object of the present invention is to provide an active-matrix addressing LCD using a lateral electric field system to which image signals are inputted according to the normal progressive method and which is manufactured by a drop filling and substrate assembling method, the display being capable of excluding residual images, visible specks and drop marks, and responding at high speed, which has not been achieved by the related art.

Another object of the present invention is to provide an active-matrix addressing LCD using a lateral electric field drive system to which image signals are inputted according to the interlace mode and which is manufactured by the drop filling and substrate assembling method, the display being capable of excluding residual images, visible specks and drop marks, and operable in a wide temperature range due to a nematic phase exhibited by the liquid crystal composition in the wide temperature range, which has not been achieved by the related art.

The present inventors have found that in order to solve a problem of the drop mark in an active-matrix addressing LCD using a lateral electric field drive system which is filled with a liquid crystal composition having an acidic mesogenic compound such as a phenol derivative added between two substrates and is manufactured by a drop filling and substrate assembling method, it is effective to add a mesogenic compound forming a hydrogen bond with the above acidic mesogenic compound such as the phenol derivative to the liquid crystal composition and is further effective to control the content at predetermined equivalents or more, which varies depending on image signals to be inputted. The present inventors have also found that when a large DC voltage is not applied to the liquid crystal as in the case that image signals of a progressive mode is inputted into a signal conversion circuit, the occurrence of a residual image can be prevented by controlling the specified content of the above described acidic mesogenic compound to 0.00010 N or more, and the appearance of the drop mark can be prevented by controlling the content of the mesogenic compound capable of hydrogen-bonding with the above described acidic mesogenic compound to 0.265 mol/L or less and to 10 or more equivalents with respect to the above described acidic mesogenic compound. The present inventors further found that when a large DC voltage is applied to the liquid crystal as in the case that the image signals of an interlace mode is inputted into the signal conversion circuit, the occurrence of the residual image can be prevented by controlling the content of the above described acidic mesogenic compound to 0.00100 N or more, and the appearance of the drop mark can be prevented by controlling a content of the mesogenic compound capable of hydrogen-bonding with the above described acidic mesogenic compound to 1.324 mol/L or less and to 150 or more equivalents with respect to the above described acidic mesogenic compound.

In other words, the present invention relates to the LCD which is filled with the liquid crystal composition having the acidic mesogenic compound added with the mesogenic compound forming the hydrogen bond with the above acidic mesogenic compound, by the drop filling and substrate assembling method, and makes the image signals of the progressive mode inputted into the signal conversion circuit from a signal source, and particularly relates to the LCD in which the content of the acidic mesogenic compound is 0.00010 N or more, and the content of the mesogenic compound capable of hydrogen-bonding with the acidic mesogenic compound is 0.265 mol/L or less and is 10 equivalents or more with respect the above described acidic mesogenic compound.

The present invention also relates to the LCD which is filled with the liquid crystal composition having the acidic mesogenic compound added with the mesogenic compound forming the hydrogen bond with the above acidic mesogenic compound, by the drop filling and substrate assembling method, and makes the image signals of an interlace mode inputted into the signal conversion circuit from the signal source, and particularly relates to the LCD in which the content of the acidic mesogenic compound is 0.00100 N or more, and the content of the mesogenic compound capable of hydrogen-bonding with the acidic mesogenic compound is 1.324 mol/L or less and is 150 equivalents or more with respect to the above described acidic mesogenic compound.

The acidic mesogenic compound is preferably a phenol derivative, and the mesogenic compound capable of hydrogen-bonding with the acidic mesogenic compound is preferably an alkoxy compound.

The LCD provided by the present invention is an active-matrix addressing LCD using a lateral electric field drive system that is filled with a liquid crystal composition into which an acidic mesogenic compound such as a phenol derivative is added, by a drop filling and substrate assembling method; employs a liquid crystal composition into which a mesogenic compound that can form a hydrogen bond with the acidic mesogenic compound is also added beforehand, and thereby can prevent a drop mark from forming due to the hydrogen-bonding reaction of the acidic mesogenic compound with water, which occurs in a manufacturing process; and employs the different optimum amount of the mesogenic compounds on the basis of the difference between a progressive mode and an interlace mode, thereby shows excellent residual image characteristics, drop mark characteristics, visible speck characteristics and response characteristics in the progressive mode, and shows excellent residual image characteristics, drop mark characteristics, visible speck characteristics and low-temperature characteristics (liquid crystal compatibility) in the interlace mode.

In addition, the LCD according to the present invention can provide a structure which does not need to seal the inlet or has no inlet such as in a in a conventional injection method, because the active matrix LCD can be manufactured by such a drop filling and substrate assembling method.

### BRIEF DESCRIPTION OF THE DRAWINGS

FIG. 1-1 is a plan view illustrating a pixel structure of an exemplary embodiment of an LCD according to the present invention;

FIG. 1-2 is a sectional view cut along the line A-A of FIG. 1-1;

FIG. 1-3 is a sectional view cut along the line B-B of FIG. 1-1;

FIG. 2 is a circuit configuration view of an exemplary embodiment of an LCD according to the present invention;

FIG. 3 illustrates a flow sheet describing a manufacturing method of an LCD according to the present invention;

FIGS. 4A to 4D illustrate a sectional view of steps starting from the step of applying a sealing material and ending in the step of laminating substrates in a vacuum, for describing a problem of the related art;

FIGS. 5A and 5B are sectional views of display pixels in a conventional active-matrix addressing LCD using a lateral electric field drive system. FIG. 5A illustrates a position on which liquid crystals have been dropped, and FIG. 5B illustrates the other position;

FIGS. 6A and 6B are sectional views of display pixels in an active-matrix addressing LCD using a lateral electric field drive system according to the present invention; FIG. 6A illustrates a position on which liquid crystals have been dropped, and FIG. 6B illustrates the other position;

FIG. 7 is a diagram showing an effect appearing when image signals of a progressive method has been input;

FIG. 8 is a diagram showing an effect appearing when image signals of an interlace method has been input;

FIG. 9 is a flow sheet describing a manufacturing method of an LCD in a related art; and

FIGS. 10A to 10C illustrate views of voltages applied onto liquid crystals in arbitrary one pixel when image signals of an interlace method has been inputted into an LCD which is a normally black mode and reverses the image signals to be inputted therein at every one frame. FIG. 10A illustrates a view of voltages applied to the liquid crystal when white is displayed. FIG. 10B illustrates a view of voltage applied to the liquid crystal when black is displayed.

FIG. 10C illustrates a view of voltages applied to one pixel in a lateral stripe display in which white and black are alternately changed at every one scanning line in a horizontal direction.

### DETAILED DESCRIPTION OF THE PREFERRED EMBODIMENTS

A “mesogenic compound” in the present invention means a compound showing mesomorphism in a state of an elementary substance, or a compound showing mesomorphism when being mixed with one or more other mesogenic compounds.

The cause of drop mark formation is estimated to be as follows.

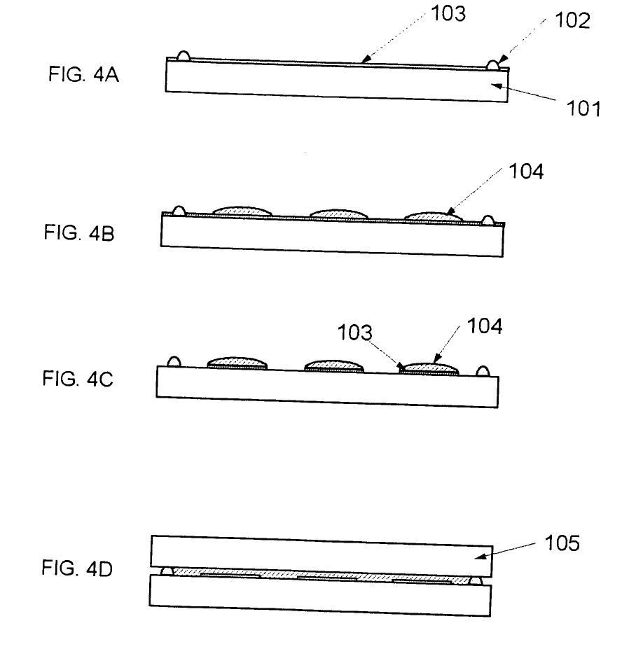

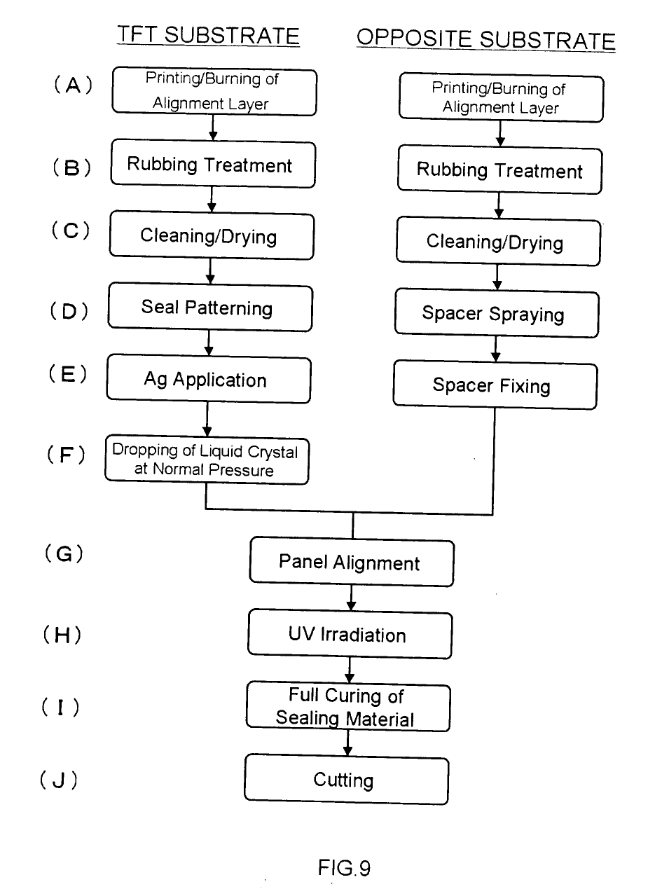

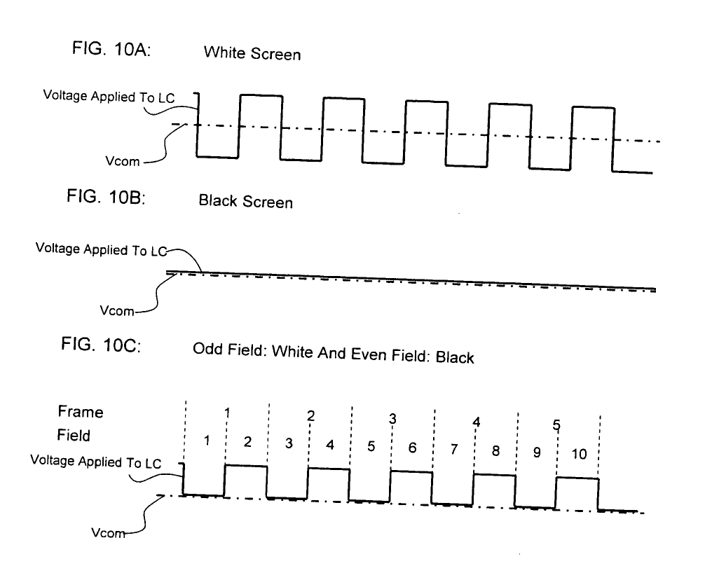

FIGS. 4A to 4D illustrate steps starting from the step of applying sealing material 102 to one substrate 101, passing the subsequent step of dropping liquid crystal 104 on a region surrounded by sealing material 102, and ending in the step of laminating the substrates in a vacuum. When the steps are carried out in an atmosphere in a clean room, which starts from the step of rubbing substrate 101 (TFT substrate in FIG. 4) of the side on which a liquid crystal composition is to be dropped, passing the step of cleaning and drying the substrate (step (C) in FIG. 9) in order to remove residue on the surface of the substrate, and ending in the step of dropping the liquid crystal onto a display region surrounded by sealing material 102 with the use of a device for dropping the liquid crystal such as a dispenser for dropping the liquid crystal, an alignment layer on the surface of substrate 101 adsorbs moisture in the atmosphere, and thin water layer 103 is formed on the utmost surface of the substrate (FIG. 4A). This is because the atmosphere in the clean room contains the moisture so that the humidity can be about 60% at 25° C. for the purpose of preventing a release electrification, and the moisture is adsorbed onto the alignment layer on the utmost surface of the substrate. In general, polyimide, which is a main component of the alignment layer, is a relatively hygroscopic material among organic polymer materials.

Next, liquid crystals where the water and gas contained have been previously removed at a pressure of 50 Pa for one hour are dropped on a region surrounded by the sealing material of one substrate by using the device for dropping the liquid crystals such as a dispenser for dropping the liquid crystals (FIG. 4B). Then, the moisture adsorbed on the utmost surface of the substrate is taken into the liquid crystals, and forms a hydrogen bond with an acidic group of an acidic mesogenic compound such as a phenol derivative contained in the liquid crystal composition. For instance, a hydroxyl group in the phenol derivative expressed by the following Formula (1):

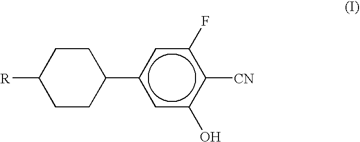

(wherein R represents alkyl or alkenyl having 7 or less carbon atoms) tends to form a hydrogen bond with water, and thus forms an oxonium ion through a coordinate bond formed between oxygen in the water molecule and hydrogen in the hydroxy group of the phenol derivative. As a result, a hydrogen ion dissociates from the hydroxy group in the phenol derivative to form a phenoxide ion, which establishes a dissociation equilibrium (shown in the following scheme (A)).

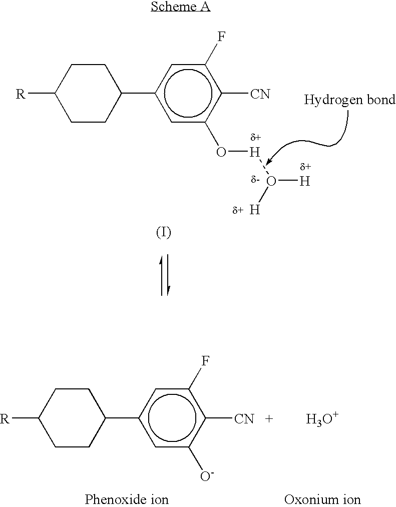

Next, one substrate 101 on which the liquid crystal composition has been dropped is held in a vacuum, before one substrate 101 and opposite substrate 105 are assembled in a vacuum. At this time, among water having deposited on the utmost surface of the substrate, water on a position on which the liquid crystal composition has not been dropped volatilizes and disappears, but water existing under the liquid crystal composition does not volatilize and remains between the substrate and the liquid crystal (FIG. 4C). When one substrate 101 and opposite substrate 105 are then assembled afterwards, liquid crystal 104 spreads over the whole regions surrounded by sealing material 102. However, the oxonium ion and the phenoxide ion exist only in the interface between one substrate 101 and the liquid crystal, accordingly do not spread over the whole regions surrounded by sealing material 102, and stay in a position on which the liquid crystal has been dropped (FIG. 4D). In other words, a large amount of the oxonium ions and the phenoxide ions exist in an inner side of the position on which the liquid crystal has been dropped, but the ions do not almost exist outside the position on which the liquid crystal has been dropped.

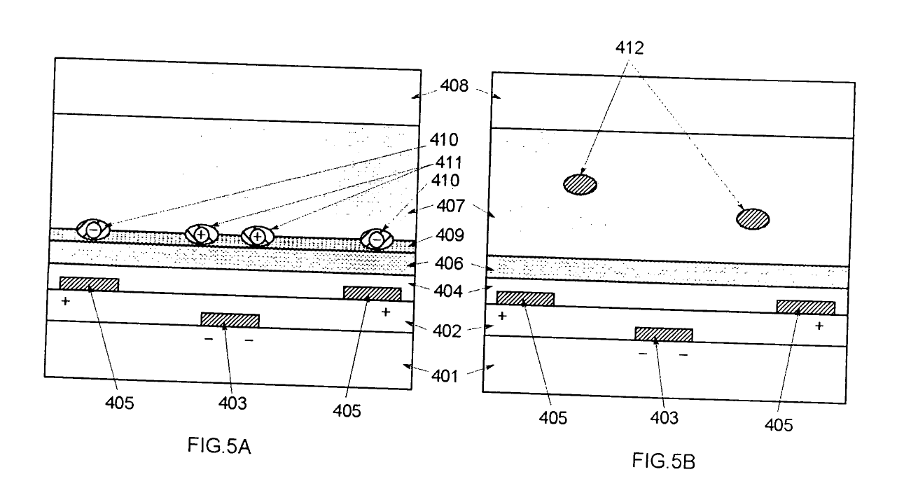

FIGS. 5A and 5B are sectional views of display pixels in a conventional active-matrix addressing LCD using a lateral electric field drive system. FIG. 5A illustrates the inner side of a position on which liquid crystals have been dropped, and FIG. 5B illustrates the outer side of the position on which the liquid crystal has been dropped. In the LCD, feed-through voltage has distribution in a display section, because a gate signal becomes dull due to an increase of the resistance of electric wiring. Driving voltage applied to the liquid crystal deviates from the drain voltage of which the polarity reverses at every predetermined frame by the amount of the feed-through voltage, but a common electrode potential is equal through out the display section. As a result, DC voltage is applied onto the liquid crystal in one part of the display section. Particularly in recent years, the length from the end to the central part of the display section gets longer and the width of a wire gets narrower as the LCD becomes large and refined, and at the same time, feed-through voltage is inclined to increase its nonuniformity. For instance, in an LCD having UXGA (length: 1,200 pixels, width: 1,600 pixels) with a screen size of 21.3 inches, the common electrode potential has a variance of about 0.3 V at the maximum in the display section. Accordingly, a DC voltage of 0.3 V at the maximum is naturally applied to the liquid crystal in the above described LCD.

In this way, when the DC voltage of about 0.3 V is applied to liquid crystals, the specific resistance of the liquid crystal remarkably decreases in the inner part of a position on which the liquid crystal has been dropped as is shown in FIG. 5A, due to oxonium ion 411 that has been formed from water 109 on the surface of alignment layer 406 and a phenol derivative and phenoxide ion 410, and DC voltage applied to the liquid crystal is cancelled in a short period of time. When the phenomenon is observed in a molecular level, oxonium ion 411 and phenoxide ion 410 seem to move so as to cancel the DC voltage applied to the liquid crystal. On the other hand, in the outer side of the position on which the liquid crystal has been dropped, phenol derivative 412 exists in the same concentration as in the position on which the liquid crystal has been dropped, as is shown in FIG. 5B, but the oxonium ion and the phenoxide ion are minimally produced, because water is minimally present there. Accordingly, in the outer side of the position on which the liquid crystal has been dropped, the oxonium ion and phenoxide ion exist in less amounts than in the inner side of the position on which the liquid crystal has been dropped, so that the specific resistance of the liquid crystal is kept relatively high, and all the DC voltage is not cancelled. In the LCD using a lateral electric field drive system in a normally black mode, the inner side of the position on which the liquid crystal has been dropped becomes darker because the DC voltage is cancelled, while the outer side of the position is brighter because the DC voltage is successively applied, and as a result, the position on which the liquid crystal has been dropped is recognized as a drop mark.

In FIGS. 5A and 5B, reference numeral 401 denotes a first transparent substrate (TFT substrate), reference numeral 402 denotes a first interlayer insulation film, reference numeral 403 denotes a common electrode, reference numeral 404 denotes a second interlayer insulation film, reference numeral 405 denotes a pixel electrode, reference numeral 407 denotes liquid crystals, and reference numeral 408 denotes a second transparent substrate (opposite substrate).

On the other hand, the LCD according to the present invention employs a liquid crystal composition containing a mesogenic compound which can form a hydrogen bond with a phenol derivative, particularly, an alkoxy compound which has superior compatibility with the liquid crystal composition and is represented by the following formula (II), and prevents oxonium ion and phenoxide ion from forming due to a reaction of the phenol derivative with water. The liquid crystal composition contains not only the phenol derivative but also, for instance, an equivalent or more of the alkoxy compound represented by the following expression (II):

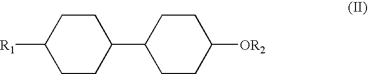

(wherein R₁ represents alkyl or alkenyl having 7 or less carbon atoms; and OR₂ represents an alkoxy group having 10 or less carbon atoms). As a result, most of the phenol derivatives form the hydrogen bond with the alkoxy compound as shown in the following scheme B:

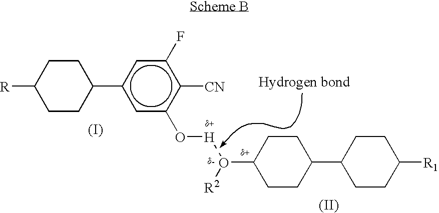

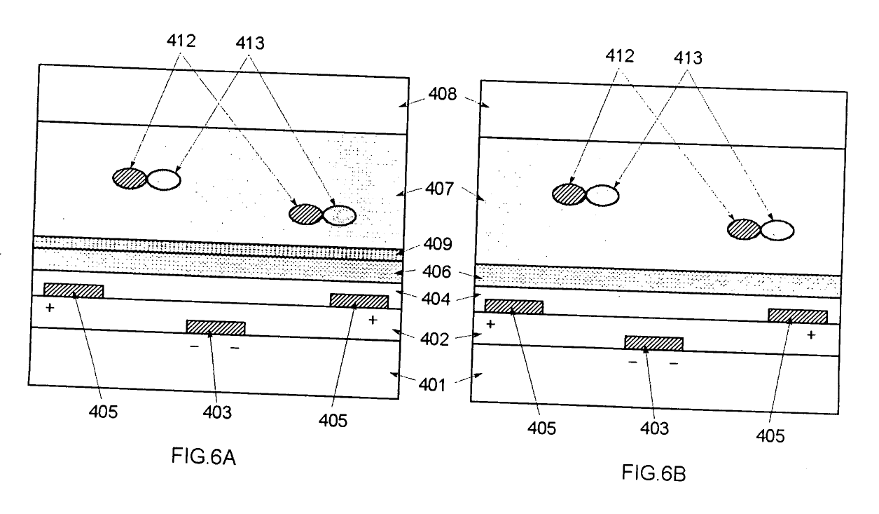

FIGS. 6A and 6B are sectional views illustrating display pixels in the active-matrix addressing LCD using a lateral electric field drive system according to an exemplary embodiment in the present invention. FIG. 6A illustrates the inner side of a position on which liquid crystals have been dropped, and FIG. 6B illustrates the outer side of the position on which the liquid crystal has been dropped. In the inner side of the position on which the liquid crystal has been dropped as shown in FIG. 6A, water 409 exists on the surface of alignment layer 406, but most of phenol derivatives 412 form the hydrogen bond with alkoxy compound 413, because the liquid crystal composition contains alkoxy compound 413 in an equivalent or more with respect to phenol derivative 412. Accordingly, the oxonium ion and the phenoxide ion are minimally produced. In addition, in the outer side of the position on which the liquid crystal has been dropped as shown in FIG. 6B, there is little water, and besides, phenol derivative 412 forms the hydrogen bond with alkoxy compound 413. Accordingly, the oxonium ion and the phenoxide ion are not produced. Thus, DC voltages applied to the outer side and the inner side of the liquid crystal position on which the liquid crystal has been dropped are approximately equal, so that the drop mark does not appear.

In addition, when DC voltage is applied to the liquid crystal with a composition which does not contain phenol derivative 412 and shows high specific resistance, a residual image appears because electrical static charge accumulates adjacent to the liquid crystal layer. However, the liquid crystal composition in the present invention contains the phenol derivative to have its specific resistance decreased, and accordingly shows adequate residual image characteristics, because of obstructing the accumulation of the electrical static charge in the vicinity of the liquid crystal layer.

Exemplary embodiment 1 and Exemplary embodiment 2 in the present invention employ a phenol derivative (I-1) described below as an acidic compound, but can employ another acidic compound as long as the compound is such an acidic compound as to be dissolved in a liquid crystal composition, have the same dissociation constant of hydrogen as in the above described phenol derivative, and decrease the specific resistance of the liquid crystal composition to a range of 1.0×10¹¹ Ωcm to 1.0×10¹² Ωcm when 0.00050 N of the compound has been added to the liquid crystal composition with the specific resistance in a range of 1.0×10¹³ Ωcm to 1.0×10¹⁴ Ωcm.

An acidic mesogenic compound which is contained in a liquid crystal composition of the present invention may be substituted phenol represented by Formula (1) or Formula (2) or substituted benzoic acid represented by Formula (3) or Formula (4).

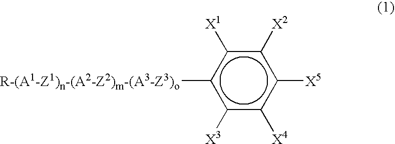

(In Formula (1), R is H, alkyl or alkenyl each having 1 or 2 to 15 carbon atoms, which is unsubstituted, monosubstituted or multisubstituted by CN or CF₃, where, in addition, one or more CH₂ groups in these radicals may be replaced, independently of one another, by —O—, —S—,

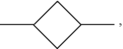

—CO—, —CO—O—, —O—CO— or —O—CO—O—, in such a way that no two O atoms are bonded directly to one another, or alternatively R is CN, F, Cl or COOR′, or is OH if being appropriate; R′ is H or R (where CN, F, OH or COOR′ is excluded);

A¹, A² and A³ are each independently

(a) 1,4-cyclohexylene or trans-1,4-cyclohexenylene, in which, in addition, one or more non-adjacent CH₂ groups may be replaced by O and/or S,

(b) 1,4-phenylene, in which, in addition, one or two CH groups may be replaced by N, and

(c) 1,4-bicyclo[2.2.2]octylene, piperidine-1,4-diyl, naphthalene-2,6-diyl, decahydronaphthalene-3,6-diyl or 1,2,3,4-tetrahydronaphthalene-2,6-diyl, in which (a) and (b) are, independently, unsubstituted, monosubstituted or multisubstituted by F;

Z¹, Z² and Z³ are each independently —CO—O—, —O—CO—, —COCH₂—, —CH₂—CO—, —CH₂O—, —OCH₂—, —CH₂CH₂—, —CH═CH—, a tolan group, —(CH₂)₄—, —(CH₂)₃CO—, —(CH₂)₂—O—CO—, —(CH₂)₂—(CO—O)—, —CH═CH—CH₂—CH₂—, —CH₂—CH₂—CH═CH—, —CH₂—CH═CH—CH₂—, or a single bond;

n, m and o are each independently 0 or 1;

X¹, X², X³, X⁴ and X⁵ are each independently OH, F, Cl, COOR′, NO₂, CN, COOH or H, and at least one of X¹, X², X³, X⁴ and X⁵ is OH).

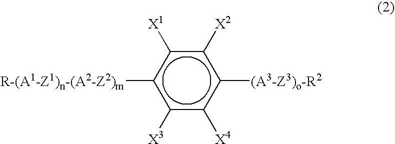

(In Formula (2), R¹ and R² are independently H, alkyl or alkenyl each having 1 or 2 to 15 carbon atoms, which are unsubstituted, monosubstituted or multisubstituted by CN or CF₃, where, in addition, one or more CH₂ groups in these radicals may be replaced, independently of one another, by —O—, —S—,

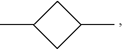

—CO—, —CO—O—, —O—CO— or —O—CO—O—, in such a way that no two O atoms are bonded directly to one another, or alternatively R¹ and R² are CN, F, Cl or COOR′, or are OH if being appropriate; R′ is H or R (where CN, F, OH or COOR′ is excluded);

A¹, A² and A³ are each independently

(a) 1,4-cyclohexylene or trans-1,4-cyclohexenylene, in which, in addition, one or more non-adjacent CH₂ groups may be replaced by O and/or S,

(b) 1,4-phenylene, in which, in addition, one or two CH groups may be replaced by N, and

(c) 1,4-bicyclo[2.2.2]octylene, piperidine-1,4-diyl, naphthalene-2,6-diyl, decahydronaphthalene-3,6-diyl or 1,2,3,4-tetrahydronaphthalene-2,6-diyl, in which (a) and (b) are, independently, unsubstituted, monosubstituted or multisubstituted by F;

Z¹, Z² and Z³ are each independently —CO—O—, —O—CO—, —COCH₂—, —CH₂—CO—, —CH₂O—, —OCH₂—, —CH₂CH₂—, —CH═CH—, a tolan group, —(CH₂)₄—, —(CH₂)₃CO—, —(CH₂)₂—O—CO—, —(CH₂)₂—(CO—O)—, —CH═CH—CH₂—CH₂—, —CH₂—CH₂—CH═CH—, —CH₂—CH═CH—CH₂—, or a single bond;

n, m and o are each independently 0 or 1;

X¹, X², X³ and X⁴ are each independently OH, F, Cl, COOR′, NO₂, CN, COOH or H, and at least one of X¹, X², X³ and X⁴ is OH).

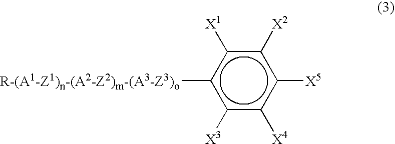

(In Formula (3), R is H, alkyl or alkenyl each having 1 or 2 to 15 carbon atoms, which is unsubstituted, monosubstituted or multisubstituted by CN or CF₃, where, in addition, one or more CH₂ groups in these radicals may be replaced, independently of one another, by —O—, —S—,

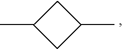

—CO—, —CO—O—, —O—CO— or —O—CO—O—, in such a way that no two O atoms are bonded directly to one another, or alternatively R is CN, F, Cl or COOR′, or are OH if being appropriate; R′ is H or R (where CN, F, OH or COOR′ is excluded);

A₁, A₂ and A₃ are each independently

(a) 1,4-cyclohexylene or trans-1,4-cyclohexenylene, in which, in addition, one or more non-adjacent CH₂ groups may be replaced by O and/or S,

(b) 1,4-phenylene, in which, in addition, one or two CH groups may be replaced by N, and

(c) 1,4-bicyclo[2.2.2]octylene, piperidine-1,4-diyl, naphthalene-2,6-diyl, decahydronaphthalene-3,6-diyl or 1,2,3,4-tetrahydronaphthalene-2,6-diyl, in which (a) and (b) are, independently, unsubstituted, monosubstituted or multisubstituted by F;

Z₁, Z₂ and Z₃ are each independently —CO—O—, —O—CO—, —COCH₂—, —CH₂—CO—, —CH₂O—, —OCH₂—, —CH₂CH₂—, —CH═CH—, a tolan group, —(CH₂)₄—, —(CH₂)₃CO—, —(CH₂)₂—O—CO—, —(CH₂)₂—(CO—O)—, —CH═CH—CH₂—CH₂—, —CH₂—CH₂—CH═CH—, —CH₂—CH═CH—CH₂—, or a single bond;

n, m and o are each independently 0 or 1;

X₁, X₂, X₃, X₄ and X₅ are each independently OH, F, Cl, COOR′, NO₂, CN, COOH or H, and at least one of X₁, X₂, X₃, X₄ and X₅ is COOH).

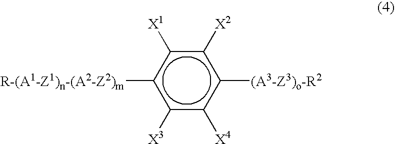

(In Formula (4), R₁ and R₂ are independently H, alkyl or alkenyl each having 1 or 2 to 15 carbon atoms, which are unsubstituted, monosubstituted or multisubstituted by CN or CF₃, where, in addition, one or more CH₂ groups in these radicals may be replaced, independently of one another, by —O—, —S—,

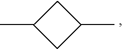

—CO—, —CO—O—, —O—CO— or —O—CO—O—, in such a way that no two 0 atoms are bonded directly to one another, or alternatively R¹ and R² are CN, F, Cl or COOR′, or are OH if being appropriate; R′ is H or R (where CN, F, OH or COOR′ is excluded);

A₁, A₂ and A₃ are each independently

(a) 1,4-cyclohexylene or trans-1,4-cyclohexenylene, in which, in addition, one or more non-adjacent CH₂ groups may be replaced by O and/or S.

(b) 1,4-phenylene, in which, in addition, one or two CH groups may be replaced by N, and

(c) 1,4-bicyclo[2.2.2]octylene, piperidine-1,4-diyl, naphthalene-2,6-diyl, decahydronaphthalene-3,6-diyl or 1,2,3,4-tetrahydronaphthalene-2,6-diyl, in which (a) and (b) are, independently, unsubstituted, monosubstituted or multisubstituted by F;

Z₁, Z₂ and Z₃ are each independently —CO—O—, —O—CO—, —COCH₂—, —CH₂—CO—, —CH₂O—, —OCH₂—, —CH₂CH₂—, —CH═CH—, a tolan group, —(CH₂)₄—, —(CH₂)₃CO—, —(CH₂)₂—O—CO—, —(CH₂)₂—(CO—O)—, —CH═CH—CH₂—CH₂—, —CH₂—CH₂—CH═CH—, —CH₂—CH═CH—CH₂—, or a single bond;

n, m and o are each independently 0 or 1;

X₁, X₂, X₃ and X₄ are each independently OH, F, Cl, COOR′, NO₂, CN, COOH or H, and at least one of X₁, X₂, X₃ and X₄ is COOH).

In addition, a mesogenic compound capable of hydrogen-bonding with an acidic mesogenic compound can be used as long as being a compound which can form a hydrogen bond with an OH group or a COOH group in the above described acidic mesogenic compound, and particularly can employ an alkoxy compound which forms a hydrogen bond with an OH group of the phenol derivative represented by Formulas (1) and (2) and a COOH group of a benzoic acid derivative represented by Formulas (3) and (4), among alkoxy compounds represented by Formulas (5) to (8).

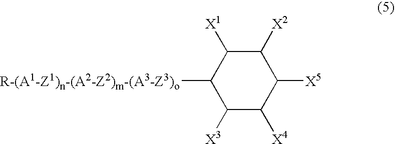

(In Formula (5), R is H, alkyl or alkenyl each having 1 or 2 to 15 carbon atoms, which is unsubstituted, monosubstituted or multisubstituted by CN or CF₃, where, in addition, one or more CH₂ groups in these radicals may be replaced, independently of one another, by —O—, —S—,

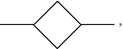

—CO—, —CO—O—, —O—CO— or —O—CO—O—, in such a way that no two O atoms are bonded directly to one another, or alternatively R is CN, F, Cl or COOR′, or are OH if being appropriate; R′ is H or R (where CN, F, OH or COOR′ is excluded);

A₁, A₂ and A₃ are each independently

(a) 1,4-cyclohexylene or trans-1,4-cyclohexenylene, in which, in addition, one or more non-adjacent CH₂ groups may be replaced by O and/or S,

(b) 1,4-phenylene, in which, in addition, one or two CH groups may be replaced by N, and

(c) 1,4-bicyclo[2.2.2]octylene, piperidine-1,4-diyl, naphthalene-2,6-diyl, decahydronaphthalene-3,6-diyl or 1,2,3,4-tetrahydronaphthalene-2,6-diyl, in which (a) and (b) are, independently, unsubstituted, monosubstituted or multisubstituted by F;

Z₁, Z₂ and Z₃ are each independently —CO—O—, —O—CO—, —COCH₂—, —CH₂—CO—, —CH₂O—, —OCH₂—, —CH₂CH₂—, —CH═CH—, a tolan group, —(CH₂)₄—, —(CH₂)₃CO—, —(CH₂)₂—O—CO—, —(CH₂)₂—(CO—O)—, —CH═CH—CH₂—CH₂—, —CH₂—CH₂—CH═CH—, —CH₂—CH═CH—CH₂—, or a single bond;

n, m and o are each independently 0 or 1;

X₁, X₂, X₃, X₄ and X₅ are each independently OH, F, Cl, COOR′, NO₂, CN, COOH, OR″ or H, R″ is H, alkyl or alkenyl each having 1 or 2 to 15 carbon atoms, which is unsubstituted, monosubstituted or multisubstituted by CN or CF₃, where, in addition, one or more CH₂ groups in these radicals may be replaced, independently of one another, by —O—, —S—,

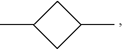

—CO—, —CO—O—, —O—CO— or —O—CO—O—, in such a way that no two O atoms are bonded directly to one another, or alternatively R″ is CN, F, Cl or COOR′″, or are OH if being appropriate; R′″ is H or R″ (where CN, F, OH or COOR″ is excluded); and at least one of X₁, X₂, X₃, X₄ and X₅ is OR′).

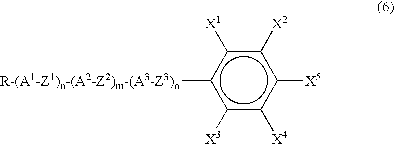

(In Formula (6), R is H, alkyl or alkenyl each having 1 or 2 to 15 carbon atoms, which is unsubstituted, monosubstituted or multisubstituted by CN or CF₃, where, in addition, one or more CH₂ groups in these radicals may be replaced, independently of one another, by —O—, —S—,

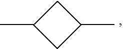

—CO—, —O—O—, —O—CO— or —O—CO—O—, in such a way that no two O atoms are bonded directly to one another, or alternatively R is CN, F, Cl or COOR′, or is OH if being appropriate; R′ is H or R (where CN, F, OH or COOR′ is excluded);

A₁, A₂ and A₃ are each independently

(a) 1,4-cyclohexylene or trans-1,4-cyclohexenylene, in which, in addition, one or more non-adjacent CH₂ groups may be replaced by O and/or S,

(b) 1,4-phenylene, in which, in addition, one or two CH groups may be replaced by N, and

(c) 1,4-bicyclo[2.2.2]octylene, piperidine-1,4-diyl, naphthalene-2,6-diyl, decahydronaphthalene-3,6-diyl or 1,2,3,4-tetrahydronaphthalene-2,6-diyl, in which (a) and (b) are, independently, unsubstituted, monosubstituted or multisubstituted by F;

Z₁, Z₂ and Z₃ are each independently —CO—O—, —O—CO—, —COCH₂—, —CH₂—CO—, —CH₂O—, —OCH₂—, —CH₂CH₂—, —CH═CH—, a tolan group, —(CH₂)₄—, —(CH₂)₃CO—, —(CH₂)₂—O—CO—, —(CH₂)₂—(CO—O)—, —CH═CH—CH₂—CH₂—, —CH₂—CH₂—CH═CH—, —CH₂—CH═CH—CH₂—, or a single bond;

n, m and o are each independently 0 or 1;

X₁, X₂, X₃, X₄ and X₅ are each independently OH, F, Cl, COOR′, NO₂, CN, COOH, OR″ or H; R″ is H, alkyl or alkenyl each having 1 or 2 to 15 carbon atoms, which is unsubstituted, monosubstituted or multisubstituted by CN or CF₃, where, in addition, one or more CH₂ groups in these radicals may be replaced, independently of one another, by —O—, —S—,

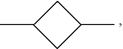

—CO—, —CO—O—, —O—CO— or —O—CO—O—, in such a way that no two O atoms are bonded directly to one another, or alternatively R″ is CN, F, Cl or COOR′″, or is OH if being appropriate; R′″ is H or R″ (where CN, F, OH or COOR″ is excluded); and at least one of X₁, X₂, X₃, X₄ and X₅ is OR′).

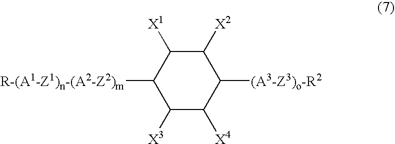

(In Formula (7), R₁ and R₂ are each independently H, alkyl or alkenyl each having 1 or 2 to 15 carbon atoms, which are unsubstituted, monosubstituted or multisubstituted by CN or CF₃, where, in addition, one or more CH₂ groups in these radicals may be replaced, independently of one another, by —O—, —S—,

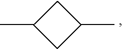

—CO—, —CO—O—, —O—CO— or —O—CO—O—, in such a way that no two O atoms are bonded directly to one another, or alternatively R₁ and R₂ are CN, F, Cl or COOR′, or are OH if being appropriate; R′ is H or R (where CN, F, OH or COOR′ is excluded);

A₁, A₂ and A₃ are each independently

(a) 1,4-cyclohexylene or trans-1,4-cyclohexenylene, in which, in addition, one or more non-adjacent CH₂ groups may be replaced by O and/or S,

(b) 1,4-phenylene, in which, in addition, one or two CH groups may be replaced by N, and

(c) 1,4-bicyclo[2.2.2]octylene, piperidine-1,4-diyl, naphthalene-2,6-diyl, decahydronaphthalene-3,6-diyl or 1,2,3,4-tetrahydronaphthalene-2,6-diyl, in which (a) and (b) are, independently, unsubstituted, monosubstituted or multisubstituted by F;

Z₁, Z₂ and Z₃ are each independently —CO—O—, —O—CO—, —COCH₂—, —CH₂—CO—, —CH₂O—, —OCH₂—, —CH₂CH₂—, —CH═CH—, a tolan group, —(CH₂)₄—, —(CH₂)₃CO—, —(CH₂)₂—O—CO—, —(CH₂)₂—(CO—O)—, —CH═CH—CH₂—CH₂—, —CH₂—CH₂—CH═CH—, —CH₂—CH═CH—CH₂—, or a single bond;

n, m and o are each independently 0 or 1;

X₁, X₂, X₃ and X₄ are each independently OH, F, Cl, COOR′, NO₂, CN, COOH, OR″ or H; R″ is H, alkyl or alkenyl each having 1 or 2 to 15 carbon atoms, which is unsubstituted, monosubstituted or multisubstituted by CN or CF₃, where, in addition, one or more CH₂ groups in these radicals may be replaced, independently of one another, by —O—, —S—,

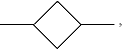

—CO—, —CO—O—, —O—CO— or —O—CO—O—, in such a way that no two O atoms are bonded directly to one another, or alternatively R″ is CN, F, Cl or COOR′″, or is OH if being appropriate; R′″ is H or R″ (where CN, F, OH or COOR″ is excluded); and at least one of X₁, X₂, X₃ and X₄ is OR′).

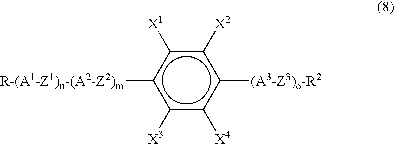

(In Formula (8), R₁ and R₂ are each independently H, alkyl or alkenyl each having 1 or 2 to 15 carbon atoms, which are unsubstituted, monosubstituted or multisubstituted by CN or CF₃, where, in addition, one or more CH₂ groups in these radicals may be replaced, independently of one another, by —O—, —S—,

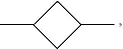

—CO—, —CO—O—, —O—CO— or —O—CO—O—, in such a way that no two O atoms are bonded directly to one another, or alternatively R₁ and R₂ are CN, F, Cl or COOR′, or are OH if being appropriate; R′ is H or R (where CN, F, OH or COOR′ is excluded);

A₁, A₂ and A₃ are each independently

(a) 1,4-cyclohexylene or trans-1,4-cyclohexenylene, in which, in addition, one or more non-adjacent CH₂ groups may be replaced by O and/or S,

(b) 1,4-phenylene, in which, in addition, one or two CH groups may be replaced by N, and

(c) 1,4-bicyclo[2.2.2]octylene, piperidine-1,4-diyl, naphthalene-2,6-diyl, decahydronaphthalene-3,6-diyl or 1,2,3,4-tetrahydronaphthalene-2,6-diyl, in which (a) and (b) are, independently, unsubstituted, monosubstituted or multisubstituted by F;

Z₁, Z₂ and Z₃ are each independently —CO—O—, —O—CO—, —COCH₂—, —CH₂—CO—, —CH₂O—, —OCH₂—, —CH₂CH₂—, —CH═CH—, a tolan group, —(CH₂)₄—, —(CH₂)₃CO—, —(CH₂)₂—O—CO—, —(CH₂)₂—(CO—O)—, —CH═CH—CH₂—CH₂—, —CH₂—CH₂—CH═CH—, —CH₂—CH═CH—CH₂—, or a single bond;

n, m and o are each independently 0 or 1;

X₁, X₂, X₃ and X₄ are each independently OH, F, Cl, COOR′, NO₂, CN, COOH, OR″ or H; R″ is H, alkyl or alkenyl each having 1 or 2 to 15 carbon atoms, which is unsubstituted, monosubstituted or multisubstituted by CN or CF₃, where, in addition, one or more CH₂ groups in these radicals may be replaced, independently of one another, by —O—, —S—,

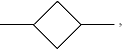

—CO—, —CO—O—, —O—CO— or —O—CO—O—, in such a way that no two O atoms are bonded directly to one another, or alternatively R″ is CN, F, Cl or COOR′″, or is OH if being appropriate; R′″ is H or R″ (where CN, F, OH or COOR″ is excluded); and at least one of X₁, X₂, X₃ and X₄ is OR′).

These alkoxy compounds were previously included in a liquid crystal composition, but they tend not to be used in an LCD which is recently required to have an improved response speed. The LCD manufactured by a drop filling and substrate assembling method according to the present invention uses such an alkoxy compound as recently tends not to be used, and thereby shows an extremely remarkable effect of being capable of preventing a drop mark due to a nonuniform distribution of an acidic mesogenic compound.

Generally, a liquid crystal composition is prepared by weighing components such as a liquid crystal composition to be contained and then mixing them (hereinafter referred to as liquid crystal before being dropped). The liquid crystal composition according to the present invention is also prepared by weighing each component to be contained and then mixing them, and accordingly it is easy to adjust a phenol derivative and an alkoxy compound to a predetermined content.

Furthermore, the present inventors compared the composition of liquid crystals before they were dropped and after they were dropped and sealed in the LCD, by instrumental analysis, and confirmed that the difference between the liquid crystal compositions of both of the phenol derivative and the alkoxy compound are about 10% respectively, which would not likely to have any influence on the results of the present invention.

The content by wt % of a phenol derivative and an alkoxy compound to be contained in the liquid crystal composition can be determined by gas chromatography mass spectroscopy (GCMS). The GCMS is an analysis method of combining a gas chromatographic analysis method (GC) with mass spectrometry (MS: mass). The GCMS analysis method identifies compounds by dissolving the liquid crystal composition into a 100 times to 10,000 times larger volume of an organic solvent such as acetone, passing the solution through a thin tube for separation referred to as a column of a gas chromatographic analysis instrument to separate each component contained in the liquid crystal composition and make them appear as a plurality of peaks, and subsequently measuring mass spectra by using a mass analysis instrument to identify what type of a compound the separated peak is.

The intensity of a peak of each component which has appeared in the gas chromatographic analysis generally is not equal to the content of each component. Specifically, when a mixture containing the weight of a compound (A) and a compound (B) has been analyzed by a gas chromatographic technique, the areas of both peaks are not always equal. The values are corrected by using a correction factor. When a mixture containing the compound (A) and the compound (B) in an arbitrary ratio, for instance, is analyzed by using the gas chromatographic technique, the weight ratio of the compound (A) to the compound (B) can be determined by the steps of: at first, measuring the relative sensitivity of each of the compound (A) and the compound (B), which is a ratio of a peak area of each compound to that of a standard substance such as toluene; determining the correction factor which is an inverse number of the relative sensitivity; and multiplying the peak area of each of the compound (A) and the compound (B) by respective correction factors. The correction factor of a component contained in an arbitrary liquid crystal composition is not known, but fortunately, the correction factor of each of the component is approximately 1, so that the ratio of the peak area of each component obtained in the gas chromatographic analysis can be considered to be wt % of each component.

The analysis precision of the gas chromatographic analysis depends on a detector, but when taking a flame ionization detector (FID) which is used as a general detector, as an example, the smallest detection quantity is 25 ng with respect to 1 mg of an introduced solution. This value corresponds to the amount of 0.001 wt % of the component contained in the original liquid crystal composition, assuming that the liquid crystal composition is diluted into 400 times with an acetone solution.

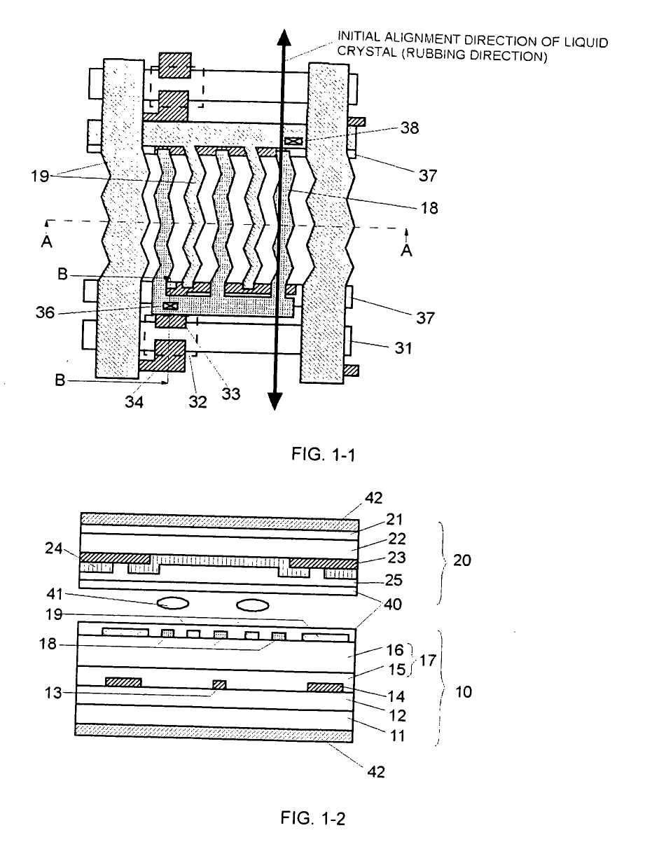

A pixel structure of the active-matrix addressing LCD using a lateral electric field drive system according to the present invention will be described with reference to FIG. 1.

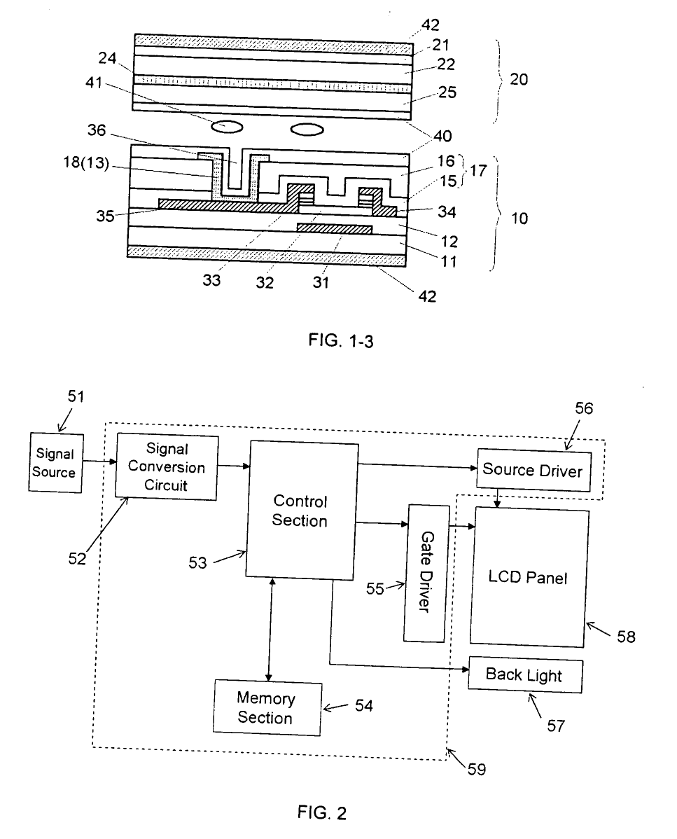

First of all, a structure of TFT substrate 10 on which a TFT is formed will be described with reference to a plan view of FIG. 1-1 and a sectional view (FIG. 1-2) cut along the line A-A in FIG. 1-1. TFT substrate 10 is composed of: a first transparent substrate 11; a first interlayer insulation film 12 formed thereon; pixel auxiliary electrode 13 and data line 14 formed on the above described first interlayer insulation film 12; and a second interlayer insulation film 17 further formed on pixel auxiliary electrode 13 and data line 14. The second interlayer insulation film 17 has a double structure in which silicon nitride film 15 and transparent acryl resin film 16 are stacked sequentially from the substrate side. On the second interlayer insulation film 17, pixel electrode 18 comprising ITO which is a transparent electroconductive film, and common electrode 19 are arranged. Pixel electrode 18 and common electrode 19 are parallel to each other, and have a zigzag structure along an extending direction (rubbing direction) of data line 14. Between the first transparent substrate 11 and the first interlayer insulation film 12, scanning line 31 is arranged, and a TFT is arranged in the vicinity of the intersection of the above described data line 14 and the above described scanning line 31. The TFT has a structure as is shown in a sectional view (FIG. 1-3) cut along the line B-B of FIG. 1-1, in which amorphous silicon 32 is formed on the first interlayer insulation film 12 on a gate electrode (scanning line 31), and the above described amorphous silicon 32 is connected to drain electrode 34 and source electrode 35 through ohmic layer 33. Source electrode 35 of the TFT is connected to pixel electrode 18 made from ITO on the second interlayer insulation film 17 through contact hole 36 of the second interlayer insulation film 17 provided on source electrode 35. Furthermore, common electrode electric wiring 37 is provided on the position between the first transparent substrate 11 and the first interlayer insulation film 12, as is shown in a plan view of FIG. 1-1. Common electrode 19 made from ITO is connected to common electrode electric wiring 37 through contact hole 38 formed between the first interlayer insulation film 12 and the second interlayer insulation film 17.

Color filter substrate 20 is arranged in the opposite side of the above described TFT substrate 10. Color filter substrate 20 includes black matrix 23 and color layer 24 formed on the second transparent substrate 22. Overcoat film 25 is formed on the above described color layer 24 and the above described black matrix 23, and a columnar spacer (not shown) for forming a gap is arranged on the above described overcoat film 25. The columnar spacer is arranged in the position facing to a region in which gate electric wiring is arranged and a data line and amorphous silicon are not arranged on TFT substrate 10.

Alignment layers 40 with uniform thickness made from polyimide or the like are formed on the opposing surfaces of TFT substrate 10 and color filter substrate 20, and are rubbing-treated, as will be described later. Then, liquid crystal 41 is placed between both substrates. In addition, polarizing plates 42 are provided on the external surfaces of TFT substrate 10 and color filter substrate 20, respectively. In addition, electroconductive layer 21 is provided in the inner side of polarizing plate 42 of color filter substrate 20.

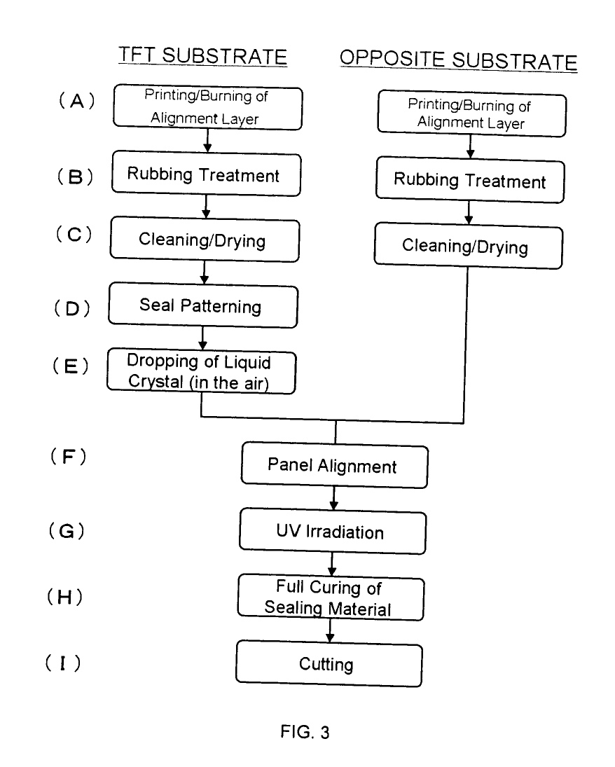

In the next place, a method of manufacturing an LCD of an exemplary embodiment in the present invention will be described with reference to FIG. 3.

The manufacturing method firstly includes: cleaning both substrates of the TFT substrate and the color filter substrate (opposite substrate); drying (IR drying) them with infrared rays to vaporize water; applying a polyimide solution onto the surface of both substrates by using a printer; temporarily burning the substrates; and fully burning the substrates to form an alignment layer with uniform thickness (step (A)); and subjecting the burnt substrates to a rubbing treatment of rubbing the surface of the alignment layer in a fixed direction, with a buffing cloth wound on a rotary metallic roller (step (B)). At this time, the rubbing direction is set so as to be perpendicular to an extending direction of a scanning line 31, as is shown in FIG. 1-1. Pixel electrode 18 and common electrode 19 are parallel to each other and are set to be inflected in a direction symmetric to the rubbing direction. An angle (β) formed by the rubbing direction and the longitudinal direction of pixel electrode 18 or common electrode 19 can be set at 15 degrees, for instance. The manufacturing method includes subsequently cleaning and drying both of the substrates for the purpose of removing the residue on the substrate surface (step (C)).

Then applying a sealing material made from an ultraviolet-curable resin or a thermosetting resin to the circumference of a display section on one substrate (for instance, TFT substrate) of a pair of opposing substrates, with a screen printing technique or a dispenser drawing technique (step (D)).

Subsequently dropping an appropriate amount of a liquid crystal composition according to the present invention, from which contaminating moisture or a gas component has been previously removed by leaving the liquid crystal composition in a vacuum, onto the display section surrounded by the sealing material on one substrate (here, TFT substrate) by using a device for dropping liquid crystals such as a dispenser for dropping liquid crystals in a clean room atmosphere (step (E)); and aligning and laminating the substrate with the other substrate (here, color filter substrate) in a vacuum chamber so that air bubbles cannot enter the space (step (F)). The substrates are assembled by placing the substrate on a stage at normal pressure in the vacuum chamber, and decompressing the vacuum chamber to 1 Pa while spending about 90 seconds, for instance. Subsequently, the manufacturing method includes: flattening the sealing material by pressing the pair of the substrates from both sides to form a desired gap, and temporarily curing the sealing material by irradiating the sealing material with ultra-violet rays or the like from the rear face of the substrate (here, TFT substrate) (step (G)); fully curing the sealing material by further heating the substrates at a predetermined temperature (step (H)); and cutting the pair of the substrates at a predetermined part in the outside of the sealing material (step (I)). Then, polarizing plates are assembled to form an LCD panel. The polarizing plate on the first transparent substrate is assembled so that the polarized light transmission axis thereof is substantially parallel to a rubbed direction of the alignment layer formed on the first transparent substrate. On the other hand, the polarizing plate on the second transparent substrate is assembled so that the polarized light transmission axis thereof is substantially perpendicular to the rubbed direction of the alignment layer formed on the second transparent substrate.

The LCD is completed by subsequently mounting a conversion board provided with a source driver, a gate driver, a back light, a power supply circuit and a signal conversion circuit for converting image signals of an inputted analog type into a digital type signal of 8 bit (256 gradation), an interface board provided with a control circuit for outputting a control signal for a back light inverter, and a signal processing board provided with a digital processing circuit, on the LCD panel.

FIG. 2 is a view of a circuit construction in one exemplary embodiment of an LCD according to the present invention, and illustrates a circuit structure for driving LCD panel 58 having the above described pixel structure according to image signals sent from signal source 51. The circuit converts image signals which has been inputted, for instance, into signal conversion circuit 52 from signal source 51, into data through a predetermined IP conversion process when the image signals is an interlace mode, and directly or through a predetermined form when the image signals is a progressive mode, and transfers the converted data to control section 53. Memory section 54 is formed of a memory device for storing a processing program or various data therein, and sends necessary data or a program to control section 53 or stores data sent from the control section therein. Furthermore, control section 53 sends a predetermined control signal to gate driver 55, source driver 56 and back light device 57 to control them. Reference numeral 59 denotes a signal processing board.

An LCD according to the present invention is an active-matrix addressing LCD using a lateral electric field drive system, but can be widely applied to the manufacture of the LCD to be produced by a drop filling and substrate assembling method with the use of a liquid crystal composition containing an acidic mesogenic compound.

The present invention relates to the active-matrix addressing LCD using a lateral electric field drive system, but is effective for preventing a residual image and a drop mark in all LCDs that use an acidic compound for lowering the resistance of liquid crystals such as in a STN (Super Twist Nematic) LCD.

The active-matrix addressing LCD using a lateral electric field drive system according to the present invention is an IPS (In-Plane Switching) LCD in which a pixel electrode and a common electrode are located in the same layer and contact with an alignment layer, but the pixel electrode may form a different layer from that of the common electrode. In addition, either the pixel electrode or the common electrode, or both electrodes may not come in contact with the alignment layer. Furthermore, the LCD according to the present invention can be applied to an FFS (Fringe Field Switching) type of an active-matrix addressing LCD using a lateral electric field drive system.

The present invention will now be described in detail below with reference to examples, but is not limited to these examples.

### Example 1

An LCD in Example 1 employed a liquid crystal composition in which 0.0125 wt % of a phenol derivative represented by the above described Formula (I) and 4 wt % of an alkoxy compound represented by the above described Formula (II) are added into a base liquid crystal composition having a specific resistance, for instance, of 5.0×10¹³ Ωcm at 25° C., and no chiral agent is added therein. The above described liquid crystal composition mainly includes a terminal-fluorinated compound and a terminal-fluorine-containing compound, and was prepared based on a concept of a liquid crystal mixture for a lateral electric field type of a display and a mixture for these LCDs described in each patent document (GB 2310669, EP 0807153, DE 19528104, DE 19528107, EP 0768359, DE 19611096 and DE 19625100), which is cited in “0036” of D2. The above described liquid crystal composition also employed 2-cyano-3-fluoro-5-(4-n-propyl-trans-cyclohexyl)phenol (hereinafter referred to as phenol derivative (I-1)) as the above described phenol derivative, because the phenol compound comparatively gradually changes the specific resistance of the liquid crystal composition with the content and is easy to adjust the resistance value, which is known in the above described known prior art. Furthermore, a compound in which R¹ is a propyl group and R² is a methyl group in the above described Formula (II) (hereinafter referred to as alkoxy compound (II-1)) was employed as the above described alkoxy compound, because the alkoxy compound of Formula (II) is known as Formula XVII of claim 9 according to Japanese Publication of International Patent Application No. 11-510199, and has low viscosity and low volatility. In addition, all the mol concentration in the present invention is shown by a value at 25° C.

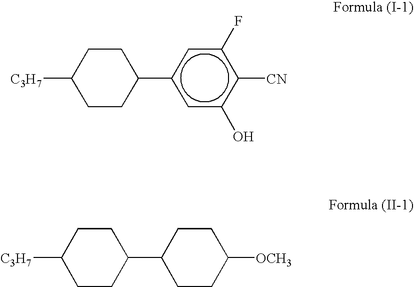

An operation effect will be now described which appears when image signals of a progressive mode is inputted into a signal conversion circuit in the active-matrix addressing LCD using a lateral electric field drive system from a signal source according to Example 1 in the present invention.

An LCD of Example 1 according to the present invention shows superior residual image characteristics. This is because the LCD contains 0.0125 wt % of a phenol derivative (I-1). A liquid crystal composition employed in the LCD of Example 1 shows a specific resistance of 5.0×10¹³ Ωcm, before the phenol derivative (I-1) and an alkoxy compound (II-1) are added to the liquid crystal composition, and shows the specific resistance of 5.0×10¹³ Ωcm after only the alkoxy compound (II-1) has been added to the liquid crystal composition, which does not change. However, the liquid crystal composition of the exemplary embodiment 1, which has been further added with the phenol derivative (I-1), shows a lowered specific resistance of 5.0×10¹¹ Ωcm, and accordingly shows adequate residual image characteristics.

The liquid crystal composition in Example 1 according to the present invention contains 4 wt % of the alkoxy compound (II-1) in addition to 0.0125 wt % of the phenol derivative (I-1). The phenol derivative (I-1) has a molecular weight of 261, and the liquid crystal composition according to Example 1 has a density of 1.05 g/ml at 25° C., so that the content of the phenol derivative (I-1) in the liquid crystal composition is 0.00050 mol/L, when being expressed by a mol concentration which is an amount (mol) of a substance per 1 liter of the liquid crystal composition. In other words, the concentration of the phenol derivative (I-1) is 0.00050 N when expressed by normality, because the phenol derivative (I-1) is a monovalent acid. Here, the normality is calculated by multiplying the mol concentration by the valency of the acid/base. Furthermore, the content of the alkoxy compound (II-1) is 0.176 mol/L by mol concentration, because the molecular weight of the alkoxy compound (II-1) is 238. The liquid crystal composition contains the alkoxy compound (II-1) in an amount corresponding to about 352 equivalents of the phenol derivative (I-1), in other words, contains 10 equivalents or more of the alkoxy compound (I-1) with respect to the phenol derivative (I-1). Then, the LCD does not show a drop mark by a reason which will be described below. In other words, the LCD according to Example 1 can solve two problems of the residual image characteristics and the drop mark at the same time.

Tables 1 to 4 show the relationship between the contents of a phenol derivative and an alkoxy compound in the liquid crystal composition which has been included in the LCD by using the above described method for manufacturing the LCD, and residual image characteristics, visible speck characteristics, drop mark characteristics and response characteristics, respectively. Image signals of a progressive mode are inputted into a signal conversion circuit of the LCD containing the liquid crystal composition shown in Tables 1 to 4, from a signal source. In addition, the content of the phenol derivative and the alkoxy compound in the liquid crystal composition in the LCD in Tables 1 to 4 is a value obtained by disassembling the LCD and analyzing the chemical composition of the contained liquid crystal composition.

The residual image characteristics shown in Table 1 have been examined after the LCD has continuously displayed a checker flag pattern for 8 hours, in which a black (0 gradation) display part and a white (255 gradation) display part each having a square shape with one side formed of 100 pixels are alternately arranged, and subsequently displayed a solid image with 127 gradation for 30 minutes; and have been evaluated as “o” when brightness unevenness matching with the position of the above described checker flag pattern is not visible on the solid image with 127 gradation, and have been evaluated as “x” when the brightness unevenness is visible.

The visible speck characteristics shown in Table 2 have been examined after the LCD has been placed in a thermo-hydrostatic chamber kept at a temperature of 60° C. and a humidity of 60%, and has displayed a white (256 gradation) display for 1000 hours; and have been evaluated as “o” when visible brightness unevenness does not newly appear in a display part of the solid image with 127 gradation, and have been evaluated as “x” when the visible brightness unevenness appears.

The drop mark characteristics shown in Table 3 have been examined by whether approximately circular brightness unevenness matching the position at which the liquid crystal was dropped is visible or not in a display part of the solid image with 17 gradation; and have been evaluated as “o” when the brightness unevenness is not visible and as “x” when the brightness unevenness is visible. The gradation with 17 steps, which has been used for evaluating the drop mark, is a gradation in which the drop mark is most easily visible among all graduations between 0 and 255.

In addition, the response characteristics in Table 4 are shown by a total value of a response time of the liquid crystal when a display has been changed from black to white and a response time when a display has been changed from white to black. The total value is a relative value to a response time of the liquid crystal composition, which has been determined as 1 when the concentration of the phenol derivative is 0 N (0 wt %) and the concentration of the alkoxy compound is 0 mol/L (0 wt %). In the above description, the response time for the change from black to white is a period of time while brightness changes from 10% to 90% with respect to the brightness in the white display, and the response time for the change from white to black is a period of time while brightness changes from 90% to 10% with respect to the brightness in the white display.

TABLE 1
Residual image characteristic

| | Concentration of phenol derivative | | | | |
|---|---|---|---|---|---|
| Concentration | 0.00000N | 0.00004N | 0.00010N | 0.00050N | 0.00100N |
| of alkoxy compound | (0.0000 wt %) | (0.0010 wt %) | (0.0025 wt %) | (0.0125 wt %) | (0.0250 wt %) |
| 0.000 mol/l(0 wt %) | x | x | ∘ | ∘ | ∘ |
| 0.044 mol/l(1 wt %) | x | x | ∘ | ∘ | ∘ |
| 0.176 mol/l(4 wt %) | x | x | ∘ | ∘ | ∘ |
| 0.265 mol/l(6 wt %) | x | x | ∘ | ∘ | ∘ |
| 0.397 mol/l(9 wt %) | x | x | ∘ | ∘ | ∘ |
| 0.618 mol/l(14 wt %) | x | x | ∘ | ∘ | ∘ |
| 1.324 mol/l(30 wt %) | x | x | ∘ | ∘ | ∘ |
| | Concentration of phenol derivative | | | | |
| Concentration | 0.00201N | 0.00402N | 0.02011N | 0.04023N | 0.06034N |
| of alkoxy compound | (0.0500 wt %) | (0.1000 wt %) | (0.5000 wt %) | (1.0000 wt %) | (1.5000 wt %) |
| 0.000 mol/l(0 wt %) | ∘ | ∘ | ∘ | ∘ | ∘ |
| 0.044 mol/l(1 wt %) | ∘ | ∘ | ∘ | ∘ | ∘ |
| 0.176 mol/l(4 wt %) | ∘ | ∘ | ∘ | ∘ | ∘ |
| 0.265 mol/l(6 wt %) | ∘ | ∘ | ∘ | ∘ | ∘ |
| 0.397 mol/l(9 wt %) | ∘ | ∘ | ∘ | ∘ | ∘ |
| 0.618 mol/l(14 wt %) | ∘ | ∘ | ∘ | ∘ | ∘ |
| 1.324 mol/l(30 wt %) | ∘ | ∘ | ∘ | ∘ | ∘ |

TABLE 2
Visible speck characteristic

| | Concentration of phenol derivative | | | | |
|---|---|---|---|---|---|
| Concentration | 0.00000N | 0.00004N | 0.00010N | 0.00050N | 0.00100N |
| of alkoxy compound | (0.0000 wt %) | (0.0010 wt %) | (0.0025 wt %) | (0.0125 wt %) | (0.0250 wt %) |
| 0.000 mol/l(0 wt %) | ∘ | ∘ | ∘ | ∘ | ∘ |
| 0.044 mol/l(1 wt %) | ∘ | ∘ | ∘ | ∘ | ∘ |
| 0.176 mol/l(4 wt %) | ∘ | ∘ | ∘ | ∘ | ∘ |
| 0.265 mol/l(6 wt %) | ∘ | ∘ | ∘ | ∘ | ∘ |
| 0.397 mol/l(9 wt %) | ∘ | ∘ | ∘ | ∘ | ∘ |
| 0.618 mol/l(14 wt %) | ∘ | ∘ | ∘ | ∘ | ∘ |
| 1.324 mol/l(30 wt %) | ∘ | ∘ | ∘ | ∘ | ∘ |
| | Concentration of phenol derivative | | | | |
| Concentration | 0.00201N | 0.00402N | 0.02011N | 0.04023N | 0.06034N |
| of alkoxy compound | (0.0500 wt %) | (0.1000 wt %) | (0.5000 wt %) | (1.0000 wt %) | (1.5000 wt %) |
| 0.000 mol/l(0 wt %) | ∘ | ∘ | ∘ | ∘ | x |
| 0.044 mol/l(1 wt %) | ∘ | ∘ | ∘ | ∘ | x |
| 0.176 mol/l(4 wt %) | ∘ | ∘ | ∘ | ∘ | x |
| 0.265 mol/l(6 wt %) | ∘ | ∘ | ∘ | ∘ | x |
| 0.397 mol/l(9 wt %) | ∘ | ∘ | ∘ | ∘ | x |
| 0.618 mol/l(14 wt %) | ∘ | ∘ | ∘ | ∘ | x |
| 1.324 mol/l(30 wt %) | ∘ | ∘ | ∘ | ∘ | x |

TABLE 3
Drop mark characteristic

| | Concentration of phenol derivative | | | | |
|---|---|---|---|---|---|
| Concentration | 0.00000N | 0.00004N | 0.00010N | 0.00050N | 0.00100N |
| of alkoxy compound | (0.0000 wt %) | (0.0010 wt %) | (0.0025 wt %) | (0.0125 wt %) | (0.0250 wt %) |
| 0.000 mol/l(0 wt %) | ∘ | x | x | x | x |
| 0.044 mol/l(1 wt %) | ∘ | ∘ | ∘ | ∘ | ∘ |
| 0.176 mol/l(4 wt %) | ∘ | ∘ | ∘ | ∘ | ∘ |
| 0.265 mol/l(6 wt %) | ∘ | ∘ | ∘ | ∘ | ∘ |
| 0.397 mol/l(9 wt %) | ∘ | ∘ | ∘ | ∘ | ∘ |
| 0.618 mol/l(14 wt %) | ∘ | ∘ | ∘ | ∘ | ∘ |
| 1.324 mol/l(30 wt %) | ∘ | ∘ | ∘ | ∘ | ∘ |
| | Concentration of phenol derivative | | | | |
| Concentration | 0.00201N | 0.00402N | 0.02011N | 0.04023N | 0.06034N |
| of alkoxy compound | (0.0500 wt %) | (0.1000 wt %) | (0.5000 wt %) | (1.0000 wt %) | (1.5000 wt %) |
| 0.000 mol/l(0 wt %) | x | x | x | x | x |
| 0.044 mol/l(1 wt %) | ∘ | x | x | x | x |
| 0.176 mol/l(4 wt %) | ∘ | ∘ | x | x | x |
| 0.265 mol/l(6 wt %) | ∘ | ∘ | ∘ | x | x |
| 0.397 mol/l(9 wt %) | ∘ | ∘ | ∘ | ∘ | x |
| 0.618 mol/l(14 wt %) | ∘ | ∘ | ∘ | ∘ | ∘ |
| 1.324 mol/l(30 wt %) | ∘ | ∘ | ∘ | ∘ | ∘ |

TABLE 4
Response characteristic

| | Concentration of phenol derivative | | | | |
|---|---|---|---|---|---|
| Concentration | 0.00000N | 0.00004N | 0.00010N | 0.00050N | 0.00100N |
| of alkoxy compound | (0.0000 wt %) | (0.0010 wt %) | (0.0025 wt %) | (0.0125 wt %) | (0.0250 wt %) |
| 0.000 mol/l(0 wt %) | 1.00 | 1.00 | 1.00 | 1.00 | 1.00 |
| 0.044 mol/l(1 wt %) | 1.04 | 1.04 | 1.04 | 1.04 | 1.04 |
| 0.176 mol/l(4 wt %) | 1.06 | 1.06 | 1.06 | 1.06 | 1.06 |
| 0.265 mol/l(6 wt %) | 1.07 | 1.07 | 1.07 | 1.07 | 1.07 |
| 0.397 mol/l(9 wt %) | 1.10 | 1.10 | 1.10 | 1.10 | 1.10 |
| 0.618 mol/l(14 wt %) | 1.19 | 1.19 | 1.19 | 1.19 | 1.19 |
| 1.324 mol/l(30 wt %) | 1.39 | 1.39 | 1.39 | 1.39 | 1.39 |
| | Concentration of phenol derivative | | | | |
| Concentration | 0.00201N | 0.00402N | 0.02011N | 0.04023N | 0.06034N |
| of alkoxy compound | (0.0500 wt %) | (0.1000 wt %) | (0.5000 wt %) | (1.0000 wt %) | (1.5000 wt %) |
| 0.000 mol/l(0 wt %) | 1.00 | 1.00 | 1.00 | 1.00 | 1.00 |
| 0.044 mol/l(1 wt %) | 1.04 | 1.04 | 1.04 | 1.04 | 1.04 |
| 0.176 mol/l(4 wt %) | 1.06 | 1.06 | 1.06 | 1.06 | 1.06 |
| 0.265 mol/l(6 wt %) | 1.07 | 1.07 | 1.07 | 1.07 | 1.07 |
| 0.397 mol/l(9 wt %) | 1.10 | 1.10 | 1.10 | 1.10 | 1.10 |
| 0.618 mol/l(14 wt %) | 1.19 | 1.19 | 1.19 | 1.19 | 1.19 |
| 1.324 mol/l(30 wt %) | 1.39 | 1.39 | 1.39 | 1.39 | 1.39 |

As is shown in Table 1, residual image characteristics are not good when the concentration of a phenol derivative is not more than 0.00004 N (not more than 0.001 wt %), but are good when the concentration of the phenol derivative is not less than 0.00010 N (not less than 0.0025 wt %). However, the residual image characteristics are not good when the concentration of the phenol derivative is excessively high. As is shown in Table 2, when the concentration of the phenol derivative exceeds 0.04023 N (1 wt %), visible specks becomes a problem. This is because the resistance of liquid crystals becomes excessively low and a voltage applied to the liquid crystals greatly decreases in one frame. Accordingly, when the concentration of the phenol derivative in a liquid crystal composition is in a range of 0.00010 N to 0.04023 N (not less than 0.0025 wt % and not less than 1 wt %), good residual image characteristics can be realized without causing a problem such as visible specks.

As is shown in Table 3, a drop mark does not appear when the concentration of the phenol derivative is in a range of 0.00004 N to 0.00201 N (not less than 0.0010 wt % and not more than 0.0500 wt %) and the concentration of an alkoxy compound is not less than 0.044 mol/L (not less than 1 wt %); and further it does not appear when the concentration of the phenol derivative is 0.00402 N (0.1 wt %) and the concentration of the alkoxy compound is not less than 0.176 mol/L (not less than 4 wt %). Further, the drop mark does not appear when the concentration of the phenol derivative is 0.02011 N (0.5 wt %) and the concentration of the alkoxy compound is not less than 0.265 mol/L (not less than 6 wt %), and does not appear when the concentration of the phenol derivative is 0.04023 N (0.1 wt %) and the concentration of the alkoxy compound is not less than 0.397 mol/L (not less than 9 wt %).

Table 5 shows an equivalent of an alkoxy compound with respect to a phenol derivative. A drop mark does not appear when the liquid crystal composition is in a region surrounded by a black thick line in Table 5. When the liquid crystal composition contains not less than 10 equivalents of the alkoxy compound with respect to the phenol derivative, the drop mark does not appear, but when the liquid crystal composition contains not less than 10 equivalents, the drop mark appears. Accordingly, when the content of the alkoxy compound is not less than 0.044 mol/L and is not less than 10 equivalents with respect to the phenol derivative, the drop mark does not appear.

However, as is shown in Table 4, the response time becomes longer as the concentration of the alkoxy compound becomes higher. Table 6 shows a relative value of a rotation viscosity coefficient of the liquid crystal composition on the condition that the rotation viscosity coefficient of the liquid crystal composition containing 0 N (0 wt %) of the phenol derivative by concentration and 0 mol/L (0 wt %) of the alkoxy compound by concentration is 1. Because the response time is proportional to the rotation viscosity coefficient, the response time becomes longer as the concentration of the alkoxy compound becomes higher. In the liquid crystal composition, a compound containing a fluorine atom which shows high electronegativity is added so as to give the liquid crystal composition dielectric anisotropy, and the fluorine atom and a lone electron pair in an oxygen atom of the alkoxy compound attract each other to increase the viscosity of the liquid crystal composition. Because the response time is proportional to the viscosity of the liquid crystal composition, the response time becomes longer as the concentration of the alkoxy compound concentration becomes higher. As long as the concentration of the alkoxy compound is 0.265 mol/L or lower (6 wt % or less), the increment of the response time is 10% or less compared to the liquid crystal composition containing 0 wt % (0 mol/L) of the alkoxy compound, and the LCD can reliably show an adequate response speed.

Accordingly, when the content of the alkoxy compound in the liquid crystal composition is in a range of 0.044 mol/L to 0.265 mol/L (1 wt % or more and 6 wt % or less), and the alkoxy compound is 10 equivalents or more of the phenol derivative, the LCD does not show a drop mark, and can reliably show the adequate response time.

TABLE 5
Equivalent ratio

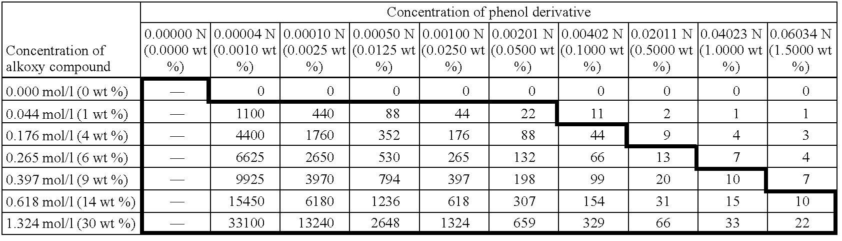

TABLE 6
Rotation viscosity coefficient (relative value)

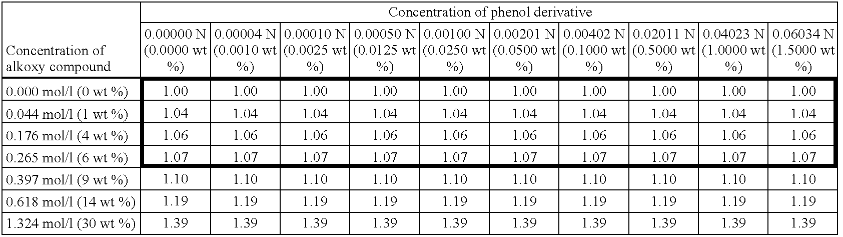

Incidentally, a liquid crystal composition cannot prevent impurities such as sodium and potassium from contaminating the composition in the manufacturing process, and accordingly the liquid crystal composition is contaminated by a very small amount of impurities. The amount of the impurities cannot be controlled to a constant value, so that the specific resistance of the liquid crystal composition varies in a wide range. The specific resistances of the liquid crystal compositions before and after a phenol derivative and an alkoxy compound in Examples according to the present invention have been added therein are 5.0×10¹³ Ωcm and 5.0×10¹¹ Ωcm respectively, but it is elucidated that the former specific resistance is in a range of 1.0×10¹³ Ωcm to 1.0×10¹⁴ Ωcm and the latter specific resistance is in a range of 1.0×10¹¹ Ωcm to 1.0×10¹² Ωcm depending on the amount of impurities, even if the liquid crystal composition has been prepared in the same composition ratio and in the same process. However, it is confirmed that the LCD shows constant residual image characteristics and drop mark characteristics even when the specific resistance of the liquid crystal composition varies, as long as the liquid crystal composition contains the same amount of the phenol derivative. The reason is considered to be because the amount of impurities entering into the liquid crystal composition in the manufacturing process of the LCD is more than that of previously contained impurities in the liquid crystal composition, further the amount of impurities entering into the liquid crystal composition in the manufacturing process is approximately constant, and accordingly the specific resistance of the liquid crystal composition sealed between two sheets of the substrates is constant as long as the content of the phenol derivative is constant.

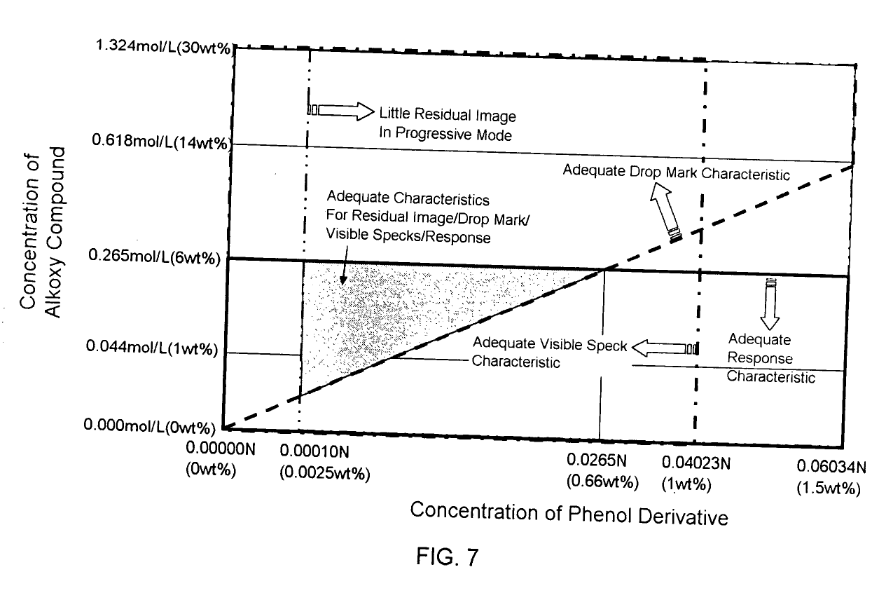

The above described effects of the LCD according to the present invention, in which the image signals of a progressive method is inputted into a signal conversion substrate from a signal source, are summarized in a diaphragm of FIG. 7. As shown in FIG. 7, the LCD shows adequate residual image characteristics, drop mark characteristics, visible speck characteristics and response characteristics in a hatched region in which the concentration of a phenol derivative is 0.00010 N (0.0025 wt %) or more, the concentration of the alkoxy compound is 0.265 mol/L (6 wt %) or less, and the content of the alkoxy compound is 10 equivalents of the phenol derivative or more.

### Example 2

In the next place, an active-matrix addressing LCD using a lateral electric field drive system according to Example 2 of the present invention will now be described. The LCD according to Example 2 of the present invention is manufactured with the same method as in Example 1, and is different from Example 1 only in the liquid crystal composition. The liquid crystal composition in Example 2 of the present invention includes a terminal-fluorinated compound and a terminal-fluorine-containing compound as a main component, 0.05 wt % of a phenol derivative (I-1) as an acidic compound and 14 wt % of an alkoxy compound (II-1), and does not contain a chiral agent.

An operation effect in the LCD of Example 2 according to the present invention will now be described, into which image signals of an interlace method are inputted, in the case when the LCD displays a lateral stripe in which white and black are alternatively changed at every one scanning line in a horizontal direction.

When the LCD which normally displays black displays the lateral stripe, a half of the direct-current voltage in white display is applied to the liquid crystal. The voltage in white display is set at 6 V in Example 2, so that 3 V of DC voltage by average shall be applied to the liquid crystal. However, the LCD of Example 2 shows adequate residual image characteristics. The LCD shows the adequate residual image characteristics by adding the phenol derivative to decrease the specific resistance of the liquid crystal, and consequently alleviating the polarization of an electrical charge due to DC voltage in the liquid crystal.

Furthermore, the liquid crystal composition in Example 2 includes 14 wt % of an alkoxy compound (II-2) in addition to 0.05 wt % of a phenol derivative (I-1). The phenol derivative (I-1) has a molecular weight of 261, and the liquid crystal composition according to the present invention has a density of 1.05 g/ml at 25° C., so that the content of the phenol derivative (I-1) is 0.00201 mol/L when being expressed by mol concentration. In addition, the phenol derivative (I-1) is a monovalent acid, so that the concentration of the phenol derivative (I-1) is 0.00201 N when being expressed by normality. Furthermore, the content of an alkoxy compound (II-1) is 0.618 mol/L when being expressed by mol concentration, because the molecular weight of the alkoxy compound (II-1) is 238. The liquid crystal composition contains the alkoxy compound (II-1) in an amount corresponding to about 307 equivalents of the phenol derivative (I-1), and contains 150 equivalents or more of the phenol derivative with respect to the alkoxy compound. Accordingly, the LCD does not show a drop mark by a reason which will be described below.

Tables 7 to 9 show residual image characteristics, visible speck characteristics and drop mark characteristics in the case when the LCD displays a lateral stripe in which white and black are alternately changed at every one scanning line in a horizontal direction while using image signals of an interlace mode. The contents of the phenol derivative and the alkoxy compound in the liquid crystal composition in the LCD of Tables 7 to 9 are values obtained by disassembling the LCD and analyzing the chemical composition of the contained liquid crystal composition.

The residual image characteristics shown in Table 7 has been examined after the LCD has continuously displayed a checker flag pattern for 30 minutes, in which a black (0 gradation) display part having a square shape with one side formed of 100 pixels and a lateral stripe display section where white (255 gradation) and black (0 gradation) are changed at every one scanning line in a horizontal direction are alternately arranged, and subsequently displayed a solid image with 127 gradation for 30 minutes; and has been evaluated as “o” when brightness unevenness matching with the position of the above described checker flag pattern is not visible on the solid image with 127 gradation, and has been evaluated as “x” when the brightness unevenness is visible.

The visible speck characteristics shown in Table 8 has been examined after the LCD has been placed in a thermo-hydrostatic chamber kept at a temperature of 60° C. and a humidity of 60%, and has displayed a lateral stripe in which white and black are alternately changed at every one scanning line in a horizontal direction for 1000 hours; and has been evaluated as “o” when visible brightness unevenness does not newly appear in a display part of the solid image with 127 gradation, and has been evaluated as “x” when the visible brightness unevenness appears.

The drop mark characteristics shown in Table 9 has been examined right after the LCD has been switched so as to display a solid image with 17 graduations after having had continuously displayed a lateral stripe in which white (255 gradation) and black (0 gradation) are alternatively changed at every one scanning line in a horizontal direction for 30 minutes; and has been evaluated as “o” when approximately circular brightness unevenness matching the position at which the liquid crystal was dropped is visible and as “×” when the brightness unevenness is visible. The gradation with 17 steps, which has been used for evaluating the drop mark, is a gradation in which the drop mark is most easily visible among all graduations between 0 and 255.

TABLE 7
Residual image characteristic

| | Concentration of phenol derivative | | | | |
|---|---|---|---|---|---|
| Concentration | 0.00000N | 0.00004N | 0.00010N | 0.00050N | 0.00100N |
| of alkoxy compound | (0.0000 wt %) | (0.0010 wt %) | (0.0025 wt %) | (0.0125 wt %) | (0.0250 wt %) |
| 0.000 mol/l(0 wt %) | x | x | x | x | ∘ |
| 0.044 mol/l(1 wt %) | x | x | x | x | ∘ |
| 0.176 mol/l(4 wt %) | x | x | x | x | ∘ |
| 0.397 mol/l(9 wt %) | x | x | x | x | ∘ |
| 0.618 mol/l(14 wt %) | x | x | x | x | ∘ |
| 1.324 mol/l(30 wt %) | x | x | x | x | ∘ |
| 1.765 mol/l(40 wt %) | x | x | x | x | ∘ |
| | Concentration of phenol derivative | | | | |
| Concentration | 0.00201N | 0.00402N | 0.02011N | 0.04023N | 0.06034N |
| of alkoxy compound | (0.0500 wt %) | (0.1000 wt %) | (0.5000 wt %) | (1.0000 wt %) | (1.5000 wt %) |
| 0.000 mol/l(0 wt %) | ∘ | ∘ | ∘ | ∘ | ∘ |
| 0.044 mol/l(1 wt %) | ∘ | ∘ | ∘ | ∘ | ∘ |
| 0.176 mol/l(4 wt %) | ∘ | ∘ | ∘ | ∘ | ∘ |
| 0.397 mol/l(9 wt %) | ∘ | ∘ | ∘ | ∘ | ∘ |
| 0.618 mol/l(14 wt %) | ∘ | ∘ | ∘ | ∘ | ∘ |
| 1.324 mol/l(30 wt %) | ∘ | ∘ | ∘ | ∘ | ∘ |
| 1.765 mol/l(40 wt %) | ∘ | ∘ | ∘ | ∘ | ∘ |

TABLE 8
Visible speck characteristic

| | Concentration of phenol derivative | | | | |
|---|---|---|---|---|---|
| Concentration | 0.00000N | 0.00004N | 0.00010N | 0.00050N | 0.00100N |
| of alkoxy compound | (0.0000 wt %) | (0.0010 wt %) | (0.0025 wt %) | (0.0125 wt %) | (0.0250 wt %) |
| 0.000 mol/l(0 wt %) | ∘ | ∘ | ∘ | ∘ | ∘ |
| 0.044 mol/l(1 wt %) | ∘ | ∘ | ∘ | ∘ | ∘ |
| 0.176 mol/l(4 wt %) | ∘ | ∘ | ∘ | ∘ | ∘ |
| 0.397 mol/l(9 wt %) | ∘ | ∘ | ∘ | ∘ | ∘ |
| 0.618 mol/l(14 wt %) | ∘ | ∘ | ∘ | ∘ | ∘ |
| 1.324 mol/l(30 wt %) | ∘ | ∘ | ∘ | ∘ | ∘ |
| 1.765 mol/l(40 wt %) | ∘ | ∘ | ∘ | ∘ | ∘ |
| | Concentration of phenol derivative | | | | |
| Concentration | 0.00201N | 0.00402N | 0.02011N | 0.04023N | 0.06034N |
| of alkoxy compound | (0.0500 wt %) | (0.1000 wt %) | (0.5000 wt %) | (1.0000 wt %) | (1.5000 wt %) |
| 0.000 mol/l(0 wt %) | ∘ | ∘ | ∘ | ∘ | x |
| 0.044 mol/l(1 wt %) | ∘ | ∘ | ∘ | ∘ | x |
| 0.176 mol/l(4 wt %) | ∘ | ∘ | ∘ | ∘ | x |
| 0.397 mol/l(9 wt %) | ∘ | ∘ | ∘ | ∘ | x |
| 0.618 mol/l(14 wt %) | ∘ | ∘ | ∘ | ∘ | x |
| 1.324 mol/l(30 wt %) | ∘ | ∘ | ∘ | ∘ | x |
| 1.765 mol/l(40 wt %) | ∘ | ∘ | ∘ | ∘ | x |

TABLE 9
Drop mark characteristic

| | Concentration of phenol derivative | | | | |
|---|---|---|---|---|---|
| Concentration | 0.00000N | 0.00004N | 0.00010N | 0.00050N | 0.00100N |
| of alkoxy compound | (0.0000 wt %) | (0.0010 wt %) | (0.0025 wt %) | (0.0125 wt %) | (0.0250 wt %) |
| 0.000 mol/l(0 wt %) | ∘ | x | x | x | x |
| 0.044 mol/l(1 wt %) | ∘ | ∘ | ∘ | ∘ | x |
| 0.176 mol/l(4 wt %) | ∘ | ∘ | ∘ | ∘ | ∘ |
| 0.397 mol/l(9 wt %) | ∘ | ∘ | ∘ | ∘ | ∘ |
| 0.618 mol/l(14 wt %) | ∘ | ∘ | ∘ | ∘ | ∘ |
| 1.324 mol/l(30 wt %) | ∘ | ∘ | ∘ | ∘ | ∘ |
| 1.765 mol/l(40 wt %) | ∘ | ∘ | ∘ | ∘ | ∘ |
| | Concentration of phenol derivative | | | | |
| Concentration | 0.00201N | 0.00402N | 0.02011N | 0.04023N | 0.06034N |
| of alkoxy compound | (0.0500 wt %) | (0.1000 wt %) | (0.5000 wt %) | (1.0000 wt %) | (1.5000 wt %) |
| 0.000 mol/l(0 wt %) | x | x | x | x | x |
| 0.044 mol/l(1 wt %) | x | x | x | x | x |
| 0.176 mol/l(4 wt %) | x | x | x | x | x |
| 0.397 mol/l(9 wt %) | ∘ | x | x | x | x |
| 0.618 mol/l(14 wt %) | ∘ | ∘ | x | x | x |
| 1.324 mol/l(30 wt %) | ∘ | ∘ | x | x | x |
| 1.765 mol/l(40 wt %) | ∘ | ∘ | x | x | x |

Table 10 shows low-temperature characteristics of a liquid crystal composition (compatibility) in which only the content of a phenol derivative and an alkoxy compound is different from those in the second Example of the present invention. The low-temperature characteristics shown in Table 10 have been examined after the liquid crystal composition has been left at −20° C. in a freezer for one week, and have been evaluated as “o” when a smectic phase has not appeared and as “x” when the smectic phase has appeared.

TABLE 10
Low-temperature characteristic

| | Concentration of phenol derivative | | | | |
|---|---|---|---|---|---|
| Concentration | 0.00000N | 0.00004N | 0.00010N | 0.00050N | 0.00100N |
| of alkoxy compound | (0.0000 wt %) | (0.0010 wt %) | (0.0025 wt %) | (0.0125 wt %) | (0.0250 wt %) |
| 0.000 mol/l(0 wt %) | ∘ | ∘ | ∘ | ∘ | ∘ |
| 0.044 mol/l(1 wt %) | ∘ | ∘ | ∘ | ∘ | ∘ |
| 0.176 mol/l(4 wt %) | ∘ | ∘ | ∘ | ∘ | ∘ |
| 0.397 mol/l(9 wt %) | ∘ | ∘ | ∘ | ∘ | ∘ |
| 0.618 mol/l(14 wt %) | ∘ | ∘ | ∘ | ∘ | ∘ |
| 1.324 mol/l(30 wt %) | ∘ | ∘ | ∘ | ∘ | ∘ |
| 1.765 mol/l(40 wt %) | x | x | x | x | x |
| | Concentration of phenol derivative | | | | |
| Concentration | 0.00201N | 0.00402N | 0.02011N | 0.04023N | 0.06034N |
| of alkoxy compound | (0.0500 wt %) | (0.1000 wt %) | (0.5000 wt %) | (1.0000 wt %) | (1.5000 wt %) |
| 0.000 mol/l(0 wt %) | ∘ | ∘ | ∘ | ∘ | ∘ |
| 0.044 mol/l(1 wt %) | ∘ | ∘ | ∘ | ∘ | ∘ |
| 0.176 mol/l(4 wt %) | ∘ | ∘ | ∘ | ∘ | ∘ |
| 0.397 mol/l(9 wt %) | ∘ | ∘ | ∘ | ∘ | ∘ |
| 0.618 mol/l(14 wt %) | ∘ | ∘ | ∘ | ∘ | ∘ |
| 1.324 mol/l(30 wt %) | ∘ | ∘ | ∘ | ∘ | ∘ |
| 1.765 mol/l(40 wt %) | x | x | x | x | x |

TABLE 11
Equivalent ratio

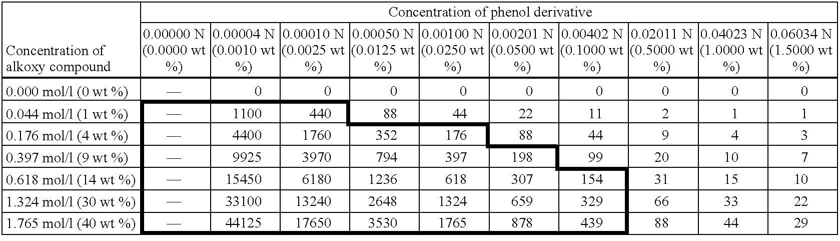

As shown in Table 7, when the image signals of an interlace method is inputted into the LCD as in Example 2, the LCD shows adequate residual image characteristics as long as the concentration of a phenol derivative is 0.00100 N or more (0.025 wt % or more), without depending on the content of an alkoxy compound. However, as is shown in Table 8, when the concentration of the phenol derivative exceeds 0.04023 N (1 wt %), visible specks becomes a problem. This is considered to be because the resistance of the liquid crystal decreases, the electric conductivity increases, and consequently, voltage to be applied to the liquid crystal greatly decreases in one frame. Accordingly, when the concentration of the phenol derivative in the liquid crystal composition is in a range of 0.00100 N to 0.04023 N (0.025 wt % or more and 1 wt % or less), adequate residual image characteristics can be realized without causing malfunction such as visible specks.

As is shown in Table 9, the drop mark does not appear when the concentration of the phenol derivative is 0.00100 N (0.025 wt %) and the concentration of the alkoxy compound is 0.176 mol/L or higher (4 wt % or higher), and does not appear when the concentration of the phenol derivative is 0.00201 N (0.05 wt %) and the concentration of the alkoxy compound is 0.397 mol/L or higher (9 wt % or higher). Further, the drop mark does not appear when the concentration of the phenol derivative is 0.00403 N (0.1 wt %) and the concentration of the alkoxy compound is 0.618 mol/L or higher (14 wt % or higher).

Table 11 shows an equivalent of an alkoxy compound with respect to a phenol derivative. A drop mark does not appear when the liquid crystal composition is in a region surrounded by a black thick line in Table 11. When the liquid crystal composition contains 150 equivalents or more of the alkoxy compound with respect to the phenol derivative, the drop mark does not appear, but when the liquid crystal composition contains 150 less than equivalents, the drop mark appears. Accordingly, when the content of the alkoxy compound is 150 equivalents or more with respect to the phenol derivative, the drop mark does not appear.

The liquid crystal composition needs to contain 0.00100 N or more (0.025 wt % or more) of the phenol derivative in order to prevent residual image characteristics, so that the concentration of the alkoxy compound needs to be 0.15 mol/L (3.4 wt %) or more which corresponds to 150 equivalents of the phenol derivative with the concentration of 0.00100 N.

The equivalent ratio in content of the alkoxy compound to the phenol derivative is 10 equivalents or more in the case of a progressive method and is 150 equivalents or more in the case of an interlace mode; and thus is larger in the case of the interlace mode. DC voltage applied to the liquid crystal is about 0.3 V at the maximum in the case of the progressive mode, as described above, but the DC voltage is about 3 V in the case of the interlace mode. The DC voltage applied to the liquid crystal in the interlace mode is larger than that in the progressive mode. In order to prevent the drop mark from appearing, the LCD compatible with the interlace mode needs to reduce the formation of oxonium ion and phenoxide ion better than that in the progressive mode, and accordingly is considered to need to make such the equivalent ratio in content of the alkoxy compound to the phenol derivative as not to cause the drop mark larger in the interlace mode than in the progressive mode.

In order to prevent the drop mark from appearing in a screen, the liquid crystal composition needs to contain much alkoxy compound, but when the concentration of the alkoxy compound exceeds 1.324 mol/L (30 wt %), the compatibility with the liquid crystal is aggravated as is shown in Table 10, and a smectic phase is formed. Accordingly, when the concentration of the phenol derivative in the liquid crystal composition is in a range of 0.15 mol/L to 1.324 mol/L (3.4 wt % or more but 30 wt % or less) and the alkoxy compound is 150 equivalents or more of the phenol derivative, the LCD does not show the drop mark and can keep an adequate compatibility of the liquid crystal composition.

On the other hand, an upper limit of concentration of the alkoxy compound is 1.324 mol/L (30 wt %), and the alkoxy compound needs to be at least 150 equivalents or more with respect to the phenol derivative, so that an upper limit of the content of the phenol derivative shall be 0.00883 N (0.22 wt %) or less.

Accordingly, when image signals of the interlace mode is inputted into a signal conversion circuit of the LCD from a signal source, the LCD can show adequate characteristics in residual image characteristics, visible speck characteristics, drop mark characteristics and the compatibility of the liquid crystal composition, by controlling the concentration of the phenol derivative into a range of 0.00100 N to 0.00883 N (0.025 wt % or more but 0.22 wt % or less), and the concentration of the alkoxy compound into a range of 0.15 mol/L to 1.324 mol (3.4 wt % or more but 30 wt % or less) and into 150 equivalents or more with respect to the phenol derivative.

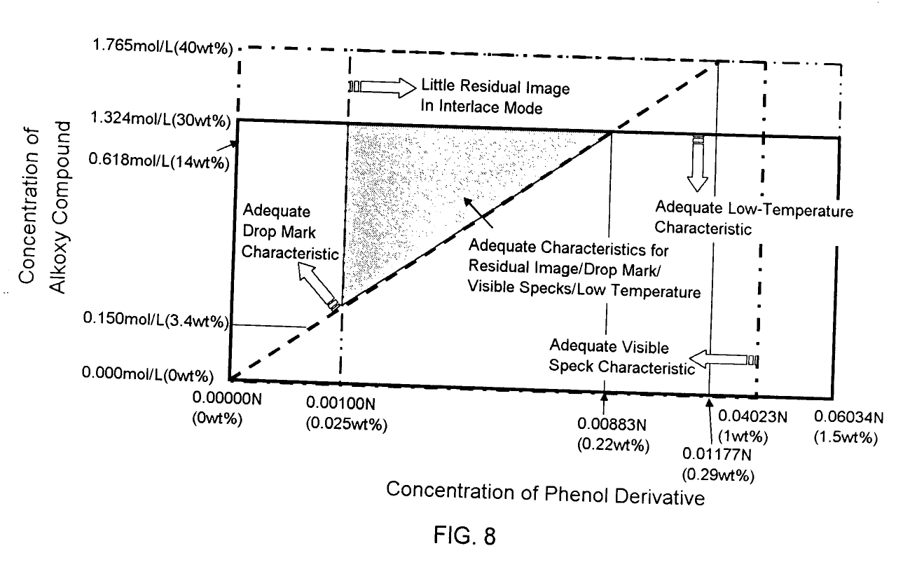

The above described effects in the case of having inputted image signals of an interlace mode into the LCD are summarized in a diagram in FIG. 8. As is shown in FIG. 8, the LCD shows adequate residual image characteristics, drop mark characteristics, visible speck characteristics and low-temperature characteristics (liquid crystal compatibility) in a hatched region in which the concentration of a phenol derivative is 0.00100 N (0.025 wt %) or higher, the concentration of the alkoxy compound is 1.324 mol/L (30 wt %) or lower, and the content of the alkoxy compound is 150 equivalents of the phenol derivative or more.

In Example 1, the image signals of the progressive mode is inputted into the LCD, but the range of the liquid crystal composition described in Example 1 can be applied to an LCD that mounts a circuit board thereon which carries image signals conversion circuit provided with an interlace-progressive conversion circuit (IP conversion circuit), as is described in “embodiment of the present invention” of D6 (Japanese Patent Application Laid-Open No. 9-236787), and that makes image signals of an interlace mode inputted therein. However, in this case, it is not avoided that the LCD becomes expensive because of the necessity of expensive IP conversion circuit.

On the other hand, in Example 2, an operation of the case is described when the image signals of the interlace mode is inputted into the LCD without the expensive IP conversion circuit as disclosed in D6 so that a lateral stripe has been displayed in which white and black are alternatively changed at every one scanning line in a horizontal direction. However, a similar problem occurs regardless of the types (frame inversion, line inversion and dot inversion) of inversion driving in the case when black (or white) and white (or black) are displayed respectively in adjacent pixels on (2N−1)-th (where N is an integer of 1 or more) and 2N-th scanning lines. The present invention is effective for the residual image and the drop mark which will be problems in the displays. In addition, the LCD according to the present invention shows an effect of improving the residual image and the drop mark when gradation except black in place of black is displayed or gradation except white in place of white is displayed, and consequently a large DC voltage is applied to the liquid crystal. Furthermore, since it is not necessary to use the expensive IP conversion circuit as disclosed in D6, the present invention can provide an inexpensive LCD in which an interlaced image signal is inputted from a signal source into a signal conversion circuit.

In Example 2, voltage in white display is set at 6 V, but it is confirmed that the LCD shows adequate drop mark characteristics in a range of 4 V to 8 V by evaluating the drop mark characteristics in the above range of the voltage of white display.

In a method for manufacturing an LCD according to the present invention, the liquid crystal composition is dropped on a display section surrounded by a sealing material of one substrate in a clean room atmosphere, but a method of dropping the liquid crystal onto the substrate in a nitrogen gas atmosphere or in a reduced pressure atmosphere other than the clean room atmosphere also shows an effect of reducing the risk of forming the drop mark.

While the invention has been particularly shown and described with reference to Examples thereof, the invention is not limited to these embodiments. It will be understood by those of ordinary skill in the art that various changes in form and details may be made therein without departing from the spirit and scope of the present invention as defined by the claims.

What is claimed is:

1. A liquid crystal display, wherein the liquid crystal display comprises a liquid crystal composition containing an acidic mesogenic compound and a mesogenic compound capable of hydrogen-bonding with the acidic mesogenic compound, the liquid crystal composition being filled by the drop filling and substrate assembling process, wherein a progressive image signal is inputted from a signal source into a signal conversion circuit.

2. The liquid crystal display according to claim 1, wherein the acidic mesogenic compound has a content of 0.00010 N or more, and the mesogenic compound capable of hydrogen-bonding with the acidic mesogenic compound has a content of 0.265 mol/L or less, corresponding to 10 equivalents or more with respect to the acidic mesogenic compound.

3. The liquid crystal display according to claim 1, wherein the acidic mesogenic compound is a phenol derivative.

4. The liquid crystal display according to claim 1, wherein the mesogenic compound capable of hydrogen-bonding with the acidic mesogenic compound is an alkoxy compound.

5. The liquid crystal display according to claim 4, wherein the acidic mesogenic compound is expressed by the following general formula (I): 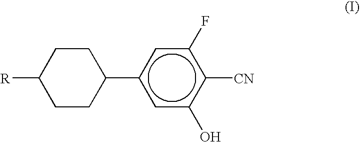
wherein R represents alkyl or alkenyl having 7 or less carbon atoms, and the alkoxy compound is expressed by the following general formula (II): 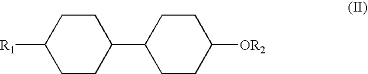
wherein R₁ represents alkyl or alkenyl having 7 or less carbon atoms; and OR₂ represents an alkoxy group having 10 or less carbon atoms.

6. The liquid crystal display according to claim 1, wherein the liquid crystal composition does not contain a chiral agent.

7. The liquid crystal display according to claim 1, wherein the liquid crystal display is an active-matrix addressing liquid crystal display using a lateral electric field drive system.

8. A liquid crystal display, wherein the liquid crystal display comprises a liquid crystal composition containing an acidic mesogenic compound and a mesogenic compound capable of hydrogen-bonding with the acidic mesogenic compound, the liquid crystal composition being filled by the drop filling and substrate assembling process, wherein an interlaced image signal is inputted from a signal source into a signal conversion circuit.

9. The liquid crystal display according to claim 8, wherein the acidic mesogenic compound has a content of 0.00100 N or more, and the mesogenic compound capable of hydrogen-bonding with the acidic mesogenic compound has a content of 1.324 mol/L or less, corresponding to 150 equivalents or more with respect to the acidic compound.

10. The liquid crystal display according to claim 8, wherein the acidic mesogenic compound is a phenol derivative.

11. The liquid crystal display according to claim 8, wherein the mesogenic compound capable of hydrogen-bonding with the acidic mesogenic compound is an alkoxy compound.

12. The liquid crystal display according to claim 11, wherein the acidic mesogenic compound is expressed by the following general formula (I): 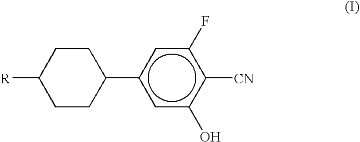
wherein R represents alkyl or alkenyl having 7 or less carbon atoms, and the alkoxy compound is expressed by the following general formula (II): 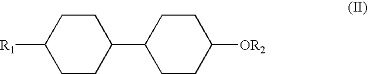
wherein R₁ represents alkyl or alkenyl having 7 or less carbon atoms; and OR₂ represents an alkoxy group having 10 or less carbon atoms.

13. The liquid crystal display according to claim 8, wherein the liquid crystal composition does not contain a chiral agent.

14. The liquid crystal display according to claim 8, wherein the liquid crystal display is an active-matrix addressing liquid crystal display using a lateral electric field drive system.
